(19) United States
(12) Patent Application Publication
(10) Pub. No.: US 2015/0294566 A1
(43) Pub. Date: Oct. 15, 2015

(54) TRIP PLANNING AND MANAGEMENT METHODS FOR AN INTELLIGENT TRANSIT SYSTEM WITH ELECTRONIC GUIDED BUSES

(71) Applicant: TOMORROW'S TRANSPORTATION TODAY, LAFAYETTE, CA (US)

(72) Inventors: Jihua Huang, RICHMOND, CA (US); Han-Shue Tan, CONCORD, CA (US); Wei-Bin Zhang, LAFAYETTE, CA (US)

(73) Assignee: TOMORROW'S TRANSPORTATION TODAY, LAFAYETTE, CA (US)

(21) Appl. No.: 14/253,674

(22) Filed: Apr. 15, 2014

(51) Int. Cl. G08G 1/133; B62D 15/02; G01S 19/13

(52) U.S. Cl. CPC G08G 1/133; G01S 19/13; B62D 15/025

(57) ABSTRACT

A method for trip management provided for an electronic guided bus that follows an electronic track. The method comprises receiving an assigned trip from a bus dispatch system, obtaining junction information based on the assigned trip, obtaining a current location of the electronic guided bus, identifying a junction the bus is at based on the current location of the bus and the junction information, and setting a main track for the bus to follow based on the desired track for the identified junction. The method provides an intelligent transit system in which dispatch processors estimate ridership demands based on the passengers' trip information, determine a plurality of trips based on estimated ridership demands, generate dispatch schedule for the trips, assign trips to the electronic guided buses, and communicate assigned trips to the electronic guided buses via communication devices.

### BACKGROUND

1. Technical Field

The present invention relates to methods and systems for dynamic dispatch of electronic guided buses based on real-time ridership demands and traffic conditions. More specifically, the present invention provides methods for electronic guided buses to choose an appropriate electronic track to follow based on their assigned trips and for a dispatch system to dynamically plan the trips and determine a dispatch schedule for bus transit based on real-time demands of ridership.

2. Related Art

The development of a low-cost, efficient, high-performance public transit system for urban cities has attracted lots of interest for decades. Subways have been built in various metropolitan areas; however, subway systems are usually very expensive and therefore are typically adopted to meet a very large ridership demand. Some cities have chosen to build light rail transportation systems, which combine the attractiveness of traditional railways with the ability to penetrate city centers at street levels. Although light rail systems are cheaper than subways, they are still far from low cost and require dedicated lanes for the rails, which reduces the traffic capacity for other vehicles. Alternatively, some cities opt to develop bus rapid transit (BRT) systems, which have much lower cost and can share lanes with other vehicles. However, regular buses cannot provide performances (such as the docking performance at stations) comparable to rail systems.

One promising solution to improve the performance of bus transit systems while preserving its low-cost advantage is electronic guided buses. Guided by on-board automated control systems, these electronic buses can provide rail-like performance such as accurate lane keeping and precision docking capabilities. Electronic guided buses typically employ vision-based, DGPS-based, or road reference based sensing technologies to identify the vehicle's lateral position in the lane. An on-board automated control system then determines the desired steering angle based on the lateral position and turns the steering wheel to the desired steering angle using a steering actuator. The on-board automated control system may also include speed sensors and distance sensors (such as radar and LIDAR) and control the speed of the bus so as to maintain a desired speed or a safe distance from a preceding vehicle.

The vision based system uses a camera to identify the lane as well as the vehicle's lateral position in the lane. However, vision-based systems have difficulties in poor visibility conditions such as fog, rain, and snow. The DGPS-based system estimates the vehicle's location on earth using its distances to at least four satellites based on the triangulation principle and then estimates the vehicle's position in the lane by mapping the vehicle location in a digital map. However, the DGPS-based systems likely suffer from signal blockage and multipath when the vehicle travels by tall buildings, tunnels, and under dense trees. The road reference based systems consist of roadway references, such as induction wires, radar-reflective tape, and magnetic markers, which are installed along the roadway and on-board sensing system that senses the vehicle's position with respect to the road reference. In particular, the road reference systems with magnetic markers have the advantages of being highly reliable and insensitive to weather conditions.

In the road reference systems with magnetic markers, discrete magnetic markers are installed in the roadway as an electronic track (i.e., rail). Magnetic field sensors are installed on the bus to measure the magnetic field strength generated by the magnetic markers as the bus travels. The measurements of the magnetic field strength are then used to determine the position between the sensors and the magnetic markers thereby estimating the bus's position with respect to the roadway. Moreover, each magnetic marker can be installed with either north polarity or south polarity facing upward to represent binary information (i.e., 1 or 0), and the sequence of the polarity forms codes that can be used to infer roadway information such as road curvature and mile posts.

When a bus transit system manages or operates on only one route or multiple separate routes for the electronic guided buses, each electronic bus only needs to follow the one track on its assigned route. However, when the bus transit system involves multiple electronic tracks that share certain segments, the electronic guided buses need to enter and exit these shared segments and then need to decide which track to follow at those junctions and even in those segments so as to correctly follow their assigned route.

Unlike rails for systems such as train systems, subways, or light rail systems, the electronic tracks may not physically intercept each other. For example, if two magnet tracks directly cross each other, the magnets at the crossing point would be close to one another, causing interference of their magnetic fields. As a result, the magnetic field sensors installed on the electronic guided bus would measure a combined magnetic field strength of the magnetic markers at the crossing instead of the magnetic field of each discrete magnetic marker. As a result, the position estimates based on the magnetic field measurement do not reflect the true position of the bus with respect to either magnetic marker, causing difficulties for the electronic guided bus to follow either track. Hence, the layout of the magnet tracks needs to be carefully designed to ensure the magnetic fields of the two tracks do not interfere with one another. Due to this unique challenge, the electronic guided bus also needs a trip management method to determine which track to follow and execute the track selection correctly so as to carry out the assigned trip.

Such on-board trip management capability also allows great freedom for the transit dispatch center to dynamically define and update trips so as to maximize the transit′ capability in meeting ridership needs without increasing the workload of the drivers or the cost of transit operations. Therefore, it is also desirable for the bus transit to have a trip planning method that estimates ridership demand and generates/updates trip arrangements (in real time) based on ridership demand to meet the riders' needs effectively while maximizing the transit's capability and efficiency.

Furthermore, when a bus transit system involves only one route or multiple separate routes for the electronic guided buses, the bus dispatch system only needs to determine the frequency or timing of the dispatch for each route independently. However, when the bus transit system involves multiple electronic tracks that share certain segments, the dispatch system can determine the dispatch time and frequency for each trip to not only satisfy the demands of ridership but also to further maximize the transit efficiency by taking advantage of the shared segments to dynamically group and separate the electronic guided buses according to the demands of ridership. Moreover, when the bus is also under automatic speed control, it is important that the bus is capable of adhering to the dispatch schedule and executing the group assignment accordingly.

It is therefore desirable to have a trip management method for the automated guided bus to determine which track to follow so as to carry out its assigned trip and a schedule management method for the automated guided bus to determine the appropriate speed so as to adhere to the dispatch schedule. It is also desirable to have a trip planning method and dynamic dispatch method to efficiently dispatch the electronic guided buses for different trips to meet the ridership demand and maximize the efficiency of the bus transit system.

### SUMMARY

In accordance with an embodiment of the present invention, a method for trip management is provided for an electronic guided bus that follows an electronic track such as a magnet track defined by magnetic markers installed in the roadway. The electronic guided bus is equipped with an electronic guidance system, which consists of a position sensing unit to detect the magnetic markers and determine the lateral deviation of the bus with respect to the magnet track, a lateral control module to compute a desired steering angle based on the lateral deviation from the position sensing unit, and a steering actuator to turn the steering wheel to the desired steering angle so as to ensure the electronic guided bus follows the magnet track.

With such an electronic guidance system, the electronic guided bus can follow a magnet track automatically. However, as mentioned earlier, when the bus transit system involves multiple electronic tracks that share certain segments, the electronic guided buses need to enter and exit these shared segments and then need to decide which track to follow at those junctions and even in those segments so as to correctly follow their assigned route. Thus, the present invention provides such a trip management method.

The trip management method receives an assigned trip from a bus dispatch system, obtains junction information based on the assigned trip, obtains a current location of the electronic guided bus, identifies a junction the bus is at based on the current location of the bus and the junction information, and sets a main track for the bus to follow based on the desired track for the identified junction. By following the main track, the electronic guided bus carries out the assigned trip automatically.

In this method, the junction information comprises a junction location and a desired track for each junction on the assigned trip. In one embodiment, the desired track for a junction is defined by a sequential number representing the desired track's location among all tracks at the junction in a predefined direction.

In one embodiment, the method obtains the current location of the electronic guided bus by detecting polarities of the magnetic markers with the position sensing unit, decoding a sequence of polarities of consecutive magnetic markers to obtain a code, and determining the current location of the bus based on the code. In another embodiment, the electronic guided bus is further equipped with a satellite-based navigation system and the current location of the bus is obtained from the satellite-based navigation system.

In an alternative embodiment, the electronic guided bus is further equipped with an electronic reader and an odometer, and radio beacons are located at specific points along the bus routes. The electronic reader detects signals from the radio beacons the bus is driving by and the current location of the bus is obtained based on the signals from the radio beacons and the travel distance from the odometer.

In a further embodiment, the trip management method further generates a reference trajectory for the electronic guided bus to gradually switch to follow the main track. The reference trajectory consists of a series of offsets, representing the distance from the track the electronic guided bus is following before switching to the main track. The lateral control module incorporates the reference trajectory to determine the desired steering angle so as to guide the electronic guided bus to smoothly transition from one magnet track to another magnet track.

The trip management method not only applies to electronic guided buses using magnetic sensing techniques, but also applies to electronic guided buses using vision-based or DGPS-based sensing techniques. Although for those systems there is no explicit track installed in the roadway, the vision-based or DGPS-based electronic guided buses still need to determine which lane or road to follow at junctions in order to carry out the assigned trips. The disclosed trip management method can be easily applied to those systems.

With this trip management method, the electronic guided buses can dynamically update or determine the track to follow so as to automatically carry out the assigned trip without increasing the workload of the drivers. Such trip management capability allows greater freedom for the transit dispatch center to dynamically define and update trips so as to maximize the transit′ capability in meeting ridership needs without increasing the cost of transit operations. Accordingly, the present invention also provides a trip planning method for a bus transit system.

Typically run in a dispatch processor or planning processor at a control center of a bus transit system, the trip planning method estimates ridership demands and generates trip arrangements based on the ridership demands. The estimation of ridership demand includes obtaining numbers of passengers on board the buses, determining origins and destinations of the passengers, obtaining historical ridership demands, and estimating ridership demand based on the number of the passengers, the origins and destinations, and the historical ridership demand. Based on the estimation of the ridership demand, the trip arrangements can then be generated and updated in real time. The generation of trip arrangements includes creating high-demand trips based on origin-destination pairs that have high ridership demand, associating origin-destination pairs with high-demand trips, and creating low-demand trips by extending high-demand trips to origins and destinations of low-demand origin-destination pairs.

With the trip management method and the trip planning method, the present invention further discloses an intelligent transit system with electronic guided buses. This intelligent transit system comprises a plurality of electronic guided buses, a plurality of ridership tracking devices for obtaining passengers' trip information, at least one communication devices (typically installed on some road infrastructure), and a control center with at least one dispatch processor. The control center may also have terminals (including displays and keyboards) for interfacing with transit personnel.

Each electronic guided bus is equipped with an electronic guidance system for receiving an assigned trip from the dispatch processor via communication devices and automatically steering the bus to carry out the assigned trip. In one embodiment, the electronic guidance system comprises a communication unit for receiving the assigned trip, a trip management module for determining a magnet track to follow based on the assigned trip so as to carry out the assigned trip, a position detection unit for providing position deviation of the bus with respect to the magnet track, a lateral control module for determining a desired steering angle based on the position deviation from the position detection unit, and a steering actuator for turning the steering wheel based on the desired steering angle.

In one embodiment, the position detection unit detects the polarity of the magnetic markers that are installed in the roadway to define magnet tracks and decodes the sequence of polarities of (consecutive) magnetic markers to obtain a code. The lateral control module determines the current location of the bus based on the code. The wireless communication unit then communicates the current location of the electronic bus (together with a time stamp) to the control center via the communication device. In another embodiment, the electronic guided bus is equipped with a vehicle location device to detect the current location of the bus location.

The trip management module determines the magnet track to follow based on the assigned trip. It first obtains the junction information based on the assigned trip (received by the communication unit); this junction information includes a junction location and a desired track for each junction on the assigned trip. The trip management module then obtains the current location of the electronic guided bus, e.g., from the lateral control module or from a vehicle location detection device. Based on the current location of the bus and the junction information, the trip management module determines whether the bus is at or approaching a junction and, if so, identifies the junction the bus is at. The trip management module then sets the magnet track for the bus to follow based on the desired track for the identified junction.

In a further embodiment, the trip management module generates a reference trajectory, which consists of a series of offsets representing the distance from the track the electronic guided bus is following before switching to the main track (i.e., the desired track at the junction). The lateral control module incorporates this reference trajectory to determine the desired steering angle such that the electronic guided bus is guided smoothly to transition from one magnet track to another magnet track.

The ridership tracking devices collect information related to ridership demand. Embodiments of the ridership tracking devices include APC (automated passenger counters), electronic fare boxes, video-based passenger counters, ticket vending machines, as well as mobile devices with transit applications for riders' trip planning. In one embodiment, the ridership tracking devices comprise a plurality of passenger counting devices, each on board an electronic guided bus for counting the passengers as they board and alight from the bus. The ridership tracking devices are connected to the communication unit of the electronic guidance system for communicating passenger counts (together with the location of the bus and time stamps) to the control center. In another embodiment, the ridership tracking devices comprise electronic fare boxes, each on board an electronic guided bus for counting passengers on board, and may also allow the passengers to input their destination. In another embodiment, a plurality of electronic fare boxes are installed at stations for counting the passengers entering and existing the stations as they collect fares from the electronic tickets of the passengers. These electronic fare boxes are connected to and output the passenger information to communication devices at the stations, which then communicate such information to the control center.

The dispatch processor then estimates ridership demands based on the passengers' trip information (from the ridership tracking devices), determines a plurality of trips based on estimated ridership demands, generates a dispatch schedule for the trips, assigns trips to the electronic guided buses, and communicates assigned trips to the electronic guided buses via the communication device. In one embodiment, the ridership demand can be estimated by obtaining numbers of the passengers on board the buses, determining origins and destinations of the passengers, obtaining historical ridership demands, and estimating ridership demand based on the number of the passengers, the origins and destinations, and the historical ridership demand. Subsequently, the plurality of trips are determined based on estimated ridership demands by creating high-demand trips based on origin-destination pairs that have high ridership demand; associating origin-destination pairs with high-demand trips, and creating low-demand trips by extending high-demand trips to origins and destinations of low-demand origin-destination pairs.

The dispatch processor further runs a dispatch process to determine the schedule for each trip based on the ridership demand as well as trip completion time and available buses, assigns each trip to an electronic guided bus, and communicates the assigned trip and the corresponding schedule to the electronic guided buses via the communication device.

Thus, with the real-time ridership demand estimation and the real-time trip arrangements based on ridership demand, this intelligent transit system can effectively meet the riders' needs while maximizing the transit's capability and efficiency. Meanwhile, with the on-board trip management capability, the electronic guided buses can dynamically update or determine the track to follow so as to automatically carry out the assigned trip without increasing the workload of the drivers.

### BRIEF DESCRIPTION OF THE DRAWINGS

Further details of the present invention are explained with the help of the attached drawings in which:

FIG. 1 shows an electronic guided bus, which is capable of following a magnet track defined by magnetic markers installed in the roadway.

FIG. 2 is a block diagram of an electronic guidance system that is on board the electronic guided bus to guide the bus along a predefined track.

FIG. 3 shows the routes of a bus transit system, where multiple routes share a corridor.

FIG. 4 is a block diagram of an electronic guidance system with wireless communication and trip management for selecting tracks based on the assigned trip.

FIG. 5 shows a track layout at a junction where two bus routes merge.

FIG. 6 shows an alternative track layout at a junction where two bus routes merge.

FIG. 7 shows another alternative track layout at a junction where two bus routes merge.

FIG. 8 shows a track layout at a junction where two bus routes separate.

FIG. 9 shows a track layout at a station where an electronic guided bus can choose to dock at the station or to pass the station without stopping.

FIG. 10 shows an alternative track layout at a station where an electronic guided bus can choose to dock at the station or to pass the station without stopping.

FIG. 11 is a flowchart showing a process involved in one embodiment of the trip management method.

FIG. 12 is a block diagram of another embodiment of the electronic guidance system with wireless communication and trip management for selecting tracks based on the assigned trip.

FIG. 13 is a flowchart showing a trip planning process involved in one embodiment of a trip planning method for determining trip arrangements based on ridership demand.

FIG. 14 is a flowchart showing a ridership estimation process.

FIG. 15 is a flowchart showing a dispatch process involved in one embodiment of a dispatch method for dispatching buses for a bus transit system.

FIG. 16 is a flowchart showing a process involved in the determination of a service interval for a trip.

FIG. 17 is a schematic showing one embodiment of an intelligent bus transit system with the electronic guided buses.

FIG. 18 is a flowchart showing a dispatch process involved in one embodiment of a dispatch method for dispatching buses in groups for a bus transit system.

FIG. 19 is a block diagram of an electronic guidance system with automatic longitudinal and lateral control as well as the trip management and the schedule management capabilities.

FIG. 20 is a flow chart showing a schedule management process involved in one embodiment of the schedule management method for determining a desired speed based on the group assignment and the dispatch schedule.

FIG. 21 is a schematic showing another embodiment of an intelligent bus transit system with the electronic guided buses.

### DETAILED DESCRIPTION

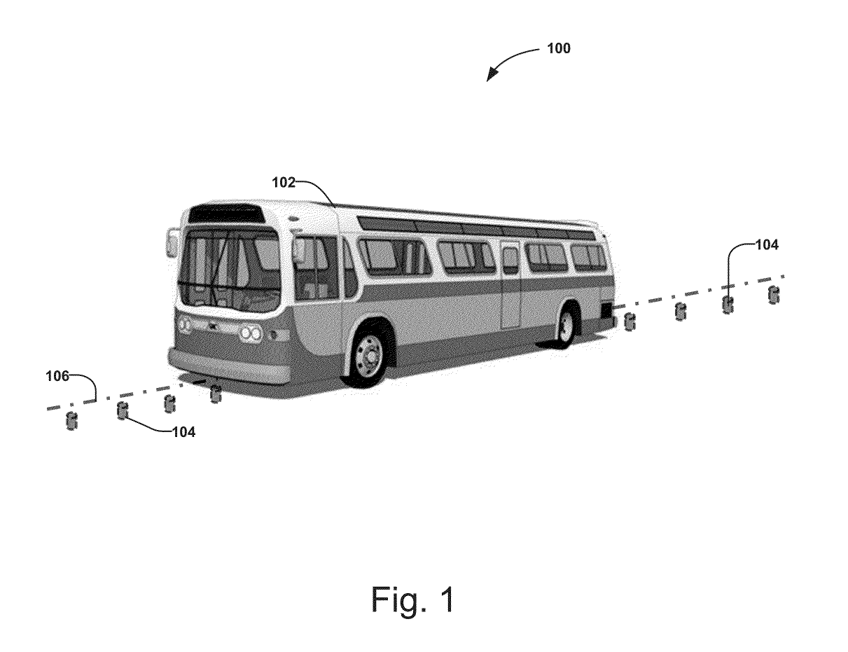

FIG. 1 shows an electronic guided bus 102, which is capable of following a magnet track 106 defined by magnetic markers 104 installed in the roadway. The magnetic markers 104 are usually permanent magnets and are typically installed under the road surface with one polarity (either north pole or south pole) facing upward. The magnetic markers 104 may be installed along the lane centerline or with a predefined offset (or predefined offsets) to the lane centerline. The distance between the magnetic markers 104 may be a fixed distance (e.g., 1 m) and may also vary depending on road curvature or other considerations.

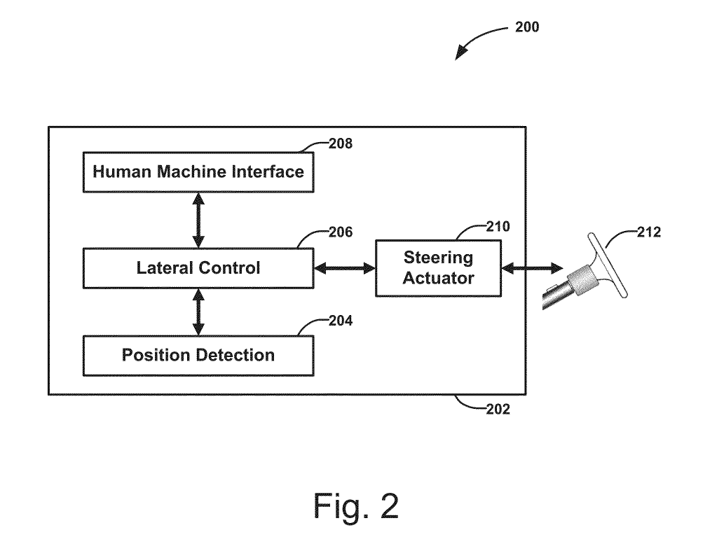

FIG. 2 is a block diagram 200 of an electronic guidance system 202 on-board the electronic guided bus 102. The electronic guidance system 202 is capable of guiding the bus 102 through the magnet track 106 defined by the magnetic markers 104. The position sensing unit 204 determines the lateral deviation of the bus 102 with respect to the magnet track 106, and since the predefined offset between the magnet track 106 and the lane centerline is known, the position sensing unit 204 may further determine the lateral deviation of the bus 102 with respect to the lane centerline.

Furthermore, the magnetic markers 104 may be installed with pre-arranged sequences of their polarity orientation to form various codes, where the position sensing unit 204 further detects the polarity of the magnetic markers 104 and decodes the sequence of marker polarity. As a magnetic marker 104 is installed with either its north pole or its south pole facing upward, each marker 104 then constitutes one bit (1 or 0) in a binary code. For example, if north is treated as 1, then the code 1100101 can be implemented with 7 consecutive magnetic markers 104 that are installed with the following sequence of polarity facing upward: north, north, south, south, north, south, and north, respectively for each marker 104. After the position sensing unit 204 determines the polarity for a marker 104, it records the polarity in the polarity queue and examines whether the polarity sequence of the last N markers 104 forms a predefined code. Various methods can be used for the decoding, such as directly comparing the sequence with the predefined codes or using code forming computations such as hamming codes. The position sensing unit 204 may further output the code for other systems to use. Exemplary methods and apparatus of the position sensing unit 204 can be found in U.S. patent application Ser. No. 14/195,713, titled, Position Sensing System For Intelligent Vehicle Guidance, filed Mar. 3, 2014, assigned the assignee of this application and herein incorporated by reference.

Based on the lateral deviation from the position sensing unit 204, a lateral control module 206 computes a desired steering angle that is needed to ensure that the bus 102 follows the magnet track 106. The lateral control module 206 also gets vehicle speed from the Control Area Network (CAN) of the bus 102 and incorporates the vehicle speed in the determination of the desired steering angle. The lateral control module 206 may also utilize the code information from the position sensing unit 204 to infer the road curvature, the magnetic marker number, the travel distance along the magnet track 106, as well as other information pre-stored in code tables, which is stored in the memory of the lateral control module 206. Various control techniques can be used to determine the desired steering angle based on the lateral deviation and other available information. Those control techniques are well-known to people skilled in the art and therefore are not described here.

A steering actuator unit 210 consists of a motor (or a hydraulic valve) that can turn a steering wheel 212, and upon receiving the desired steering angle from the lateral control module 206, the motor (or the hydraulic valve) turns the steering wheel 212 to the desired steering angle. The steering actuator unit 210 may also include a servo control processor (not shown) as well as relevant sensors that measure the steering wheel angle. The servo control processor further determines the angle that the motor (or the hydraulic valve) should turn the wheel 212 to (or the torque the motor or valve should exert onto the steering wheel 212) based on the desired steering angle from the lateral control module 206.

The electronic guidance system 202 further includes a human machine interface (HMI) unit 208. The HMI unit 208 provides information to and receives commands from the operator of the bus 102 (or the monitoring personnel) and also receives system operating status from and sends the operator's commands to the lateral control module 206. The HMI unit 208 may also monitor the integrity of the information and system operation. The HMI unit 208 consists of audio and visual feedback to the operator as well as switches and panels that can be operated by the operator.

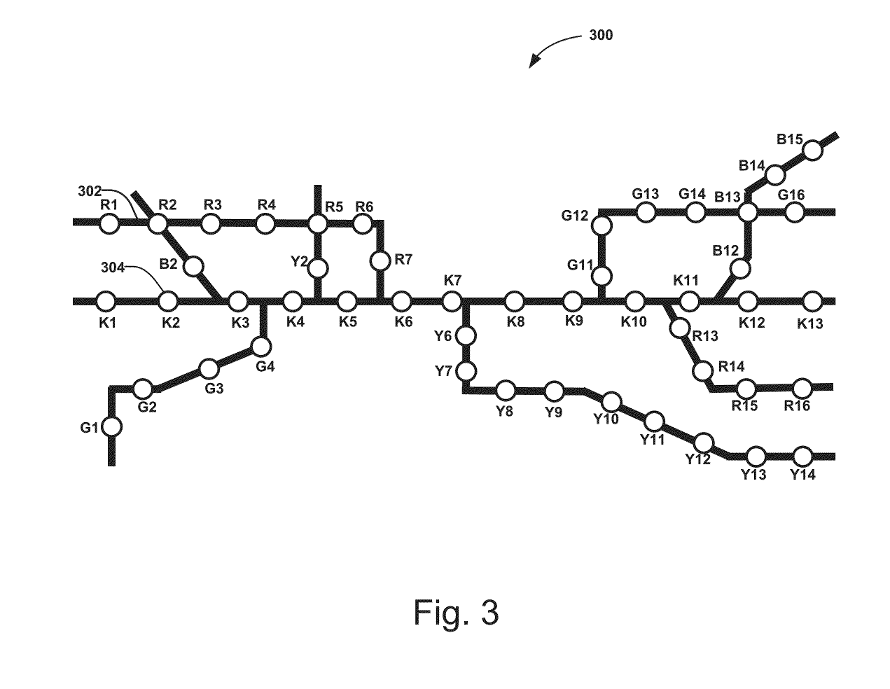

The electronic guidance system 202 in FIG. 2 is capable of guiding the bus 102 along the magnet track 106. However, a typical bus transit system manages multiple routes (sometimes hundreds of routes for bus transit systems at big metropolitan areas), and it is common that different routes share transit terminals or transfer stations for transferring passengers whose trips involve multiple routes. It is also common for different routes to share consecutive route segments, also called corridors, especially at downtowns, attractions, campuses, etc. FIG. 3 shows a bus transit system 300, where multiple routes share a corridor. Five routes 302 are shown and are sometimes referred to herein as the R (red) line, B (blue) line, K (black) line, G (green) line, and Y (yellow) line. Stations 304 are marked by round circles, where each station 304 is referred to by a letter representing the line and a number representing its location on the line from left to right. For example, the stations 304 on the K line are labelled as K1, K2, K3, etc., while the stations 304 on the R line are labelled as R1, R2, R3, and so on.

As mentioned above, unlike rails for trains, subways, or light rail systems, the electronic tracks may not be able to physically intercept with each other. This is especially true for the magnet tracks 106 whose direct crossing could cause interference of magnetic fields at the crossing point and corrupt the lateral deviation estimation based on measurements of magnetic field strength. Therefore, the layout of the magnet tracks 106 needs to be carefully designed to ensure the magnetic fields of multiple tracks do not interfere with one another. Moreover, the electronic guided bus 102 also needs a trip management method to determine which track to follow and execute the track selection correctly so as to carry out the assigned trip.

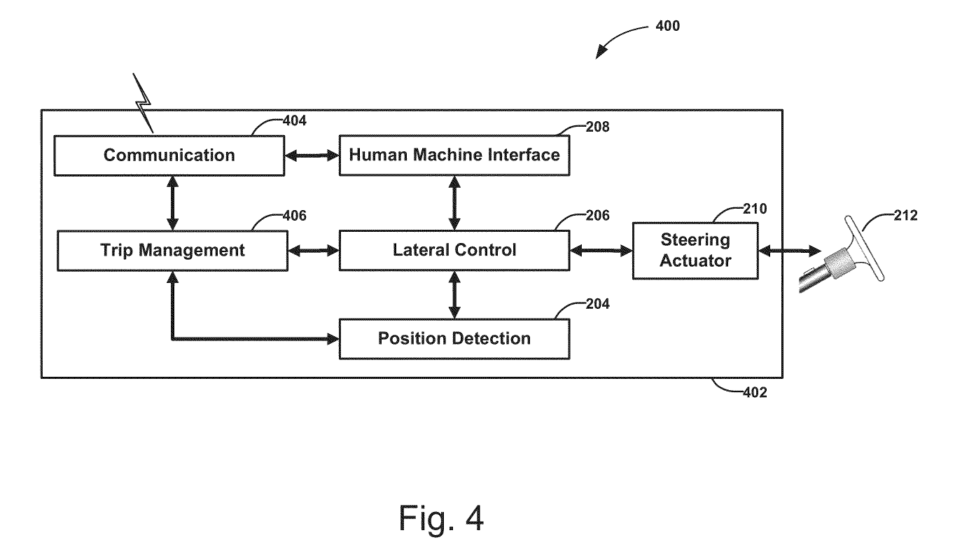

FIG. 4 is a block diagram 400 of an electronic guidance system 402 including a wireless communication unit 404 and a trip management module 406 to implement the trip management method, where like elements to the system 202 are identified by the same reference number. Similar to the electronic guidance system 202 in FIG. 2, the electronic guidance system 402 includes the position detection unit 204, the lateral control module 206, the steering actuator 210 and the HMI 208. In addition, the electronic guidance system 402 further comprises a wireless communication unit 404, which communicates with a control center (not shown) of the bus transit system. The wireless communication unit 404 receives a trip assignment from the control center, e.g., from a dispatch system running in the control center, and provides the received trip assignment to a trip management module 406. The trip management module 406 then selects a main magnet track to follow in order to carry out the assigned trip based on the assigned trip and the location of the bus 102 detected by the position detection unit 204. The trip management module 406 then outputs the selected main track to the lateral control module 206, which then guides the bus 102 along the main track accordingly. The trip management module 406 and the lateral control module 206 may reside in the same processor (e.g., an embedded processor or an industrial PC). Alternatively, the trip management module 406 may reside in a separate processor.

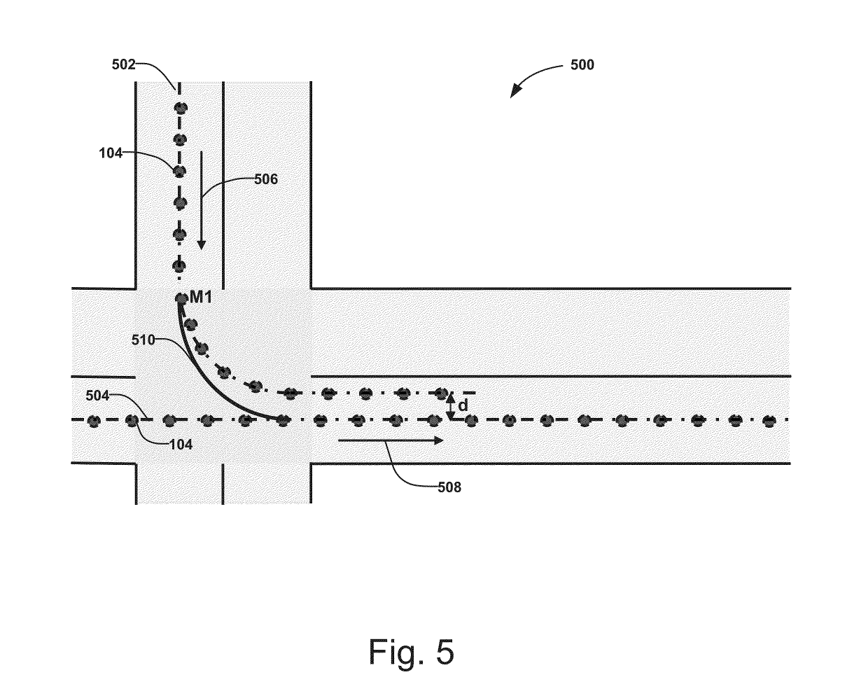

FIG. 5 shows a track layout 500 at a junction where two bus routes merge. One example of such a junction is the junction between the Y line and the K line between stations K4 and K5 in FIG. 3. For description purpose, the directions of travel are marked by arrows 506 and 508; however, the directions can be reversed as well. For illustration purpose, magnet tracks 502 and 504 are centered at the lane center before merging; however, the magnet tracks 502 and 504 can be offset from the lane center. As the magnet track 502 for the Y line turns to merge with the magnet track 504 for the K line, the magnet track 502 starts to gradually move towards one side so that the two tracks 502 and 504 have an adequate distance (marked as “d” in FIG. 5) after they merge. The distance d is to ensure no interference between the magnetic fields of the markers 104 on the two tracks 502 and 504. Typically d would be no less than 0.5 m.

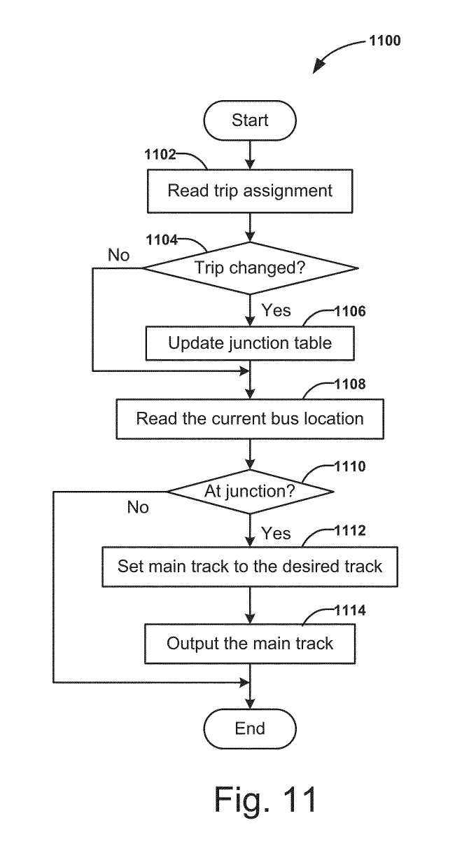

After merging, one magnet track can end. In FIG. 5, the magnet track 502 for the Y line ends and the electronic guided bus 102 then follows the magnet track 504 for the K line after the junction. The electronic guided bus 102 on the Y line will be guided to follow a trajectory 510 to transition from the magnet track 502 to the magnet track 504. Further details will be provided with FIG. 11.

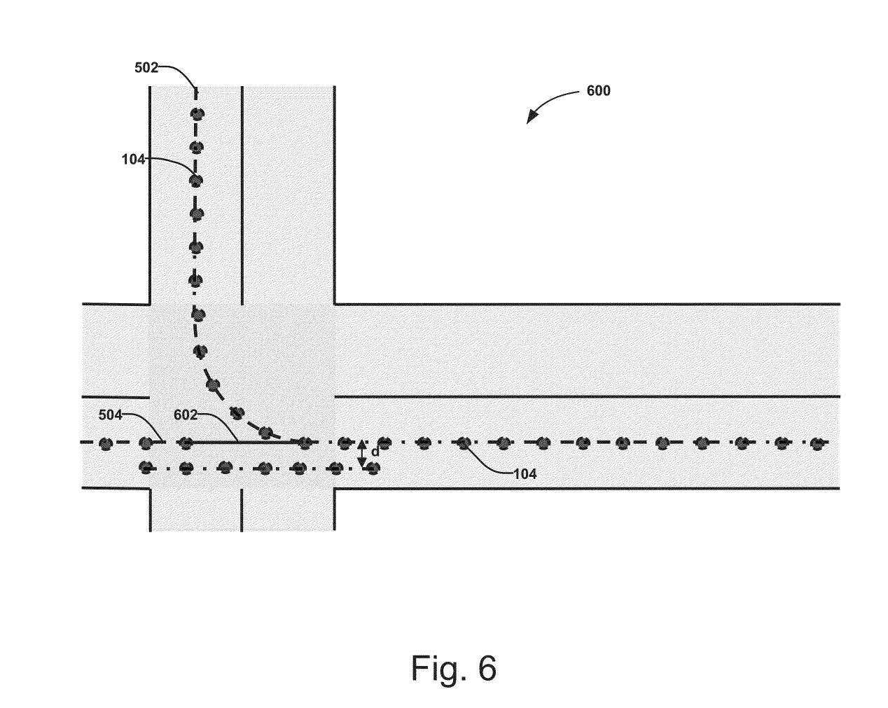

FIG. 6 shows an alternative track layout 600 at a junction where two bus routes merge, where like elements to other track layouts are identified by the same reference numbers. In the layout 600, the magnet track 504 for the K line shifts to one side and ends after the junction. An electronic guided bus traveling on the Y line will follow the magnet track 502 for the Y line while an electronic guided bus traveling on the K line will follow a trajectory 602 to transition from the magnet track 504 to the magnet track 502.

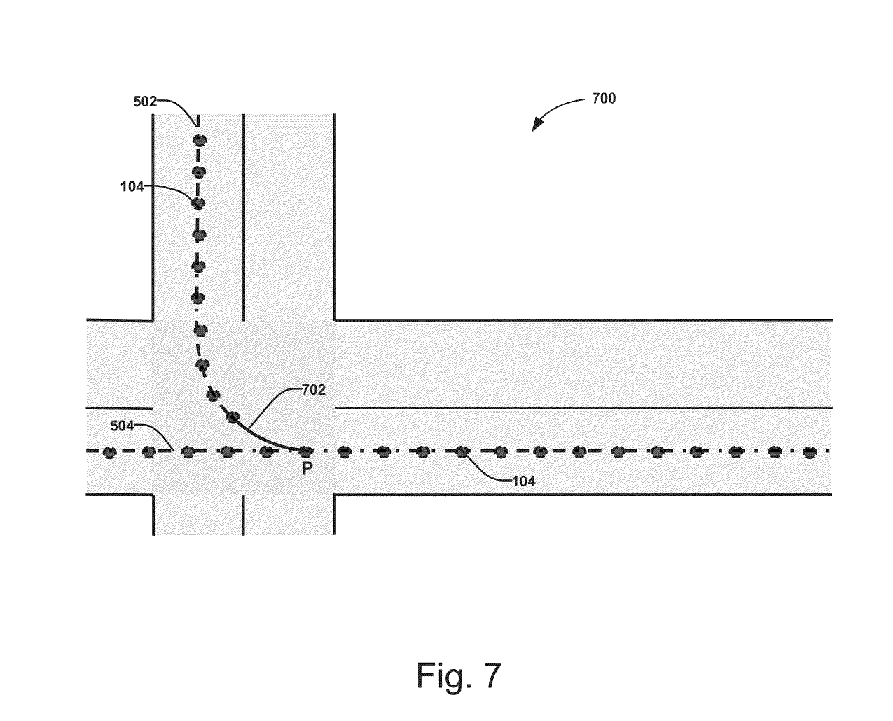

FIG. 7 shows another alternative track layout 700 at a junction where two bus routes merge, where like elements to other track layouts are identified by the same reference numbers. In the layout 700, each magnet track 502 and 504 remains at the lane center but one of the tracks 502 or 504 ends shortly before the crossing point (or merge point) P. In FIG. 7, the magnet track 502 for the Y line ends before the merge point P and an electronic guided bus on the Y line will continue in a dead-reckoning manner before reaching the magnet track 504 on the K line.

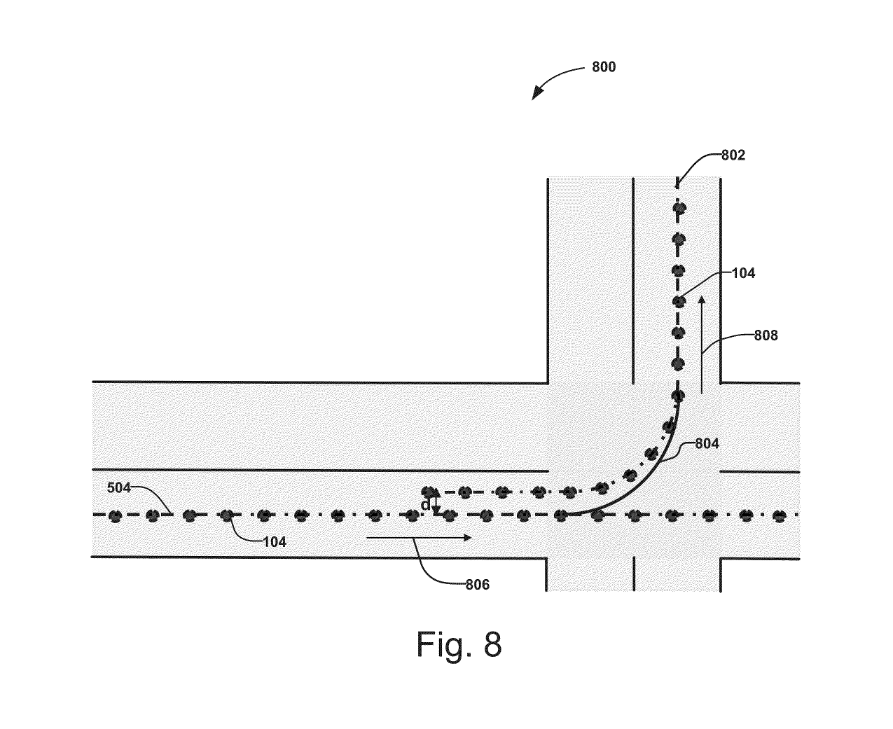

FIG. 8 shows a track layout 800 at a junction where two bus routes separate, where like elements to other track layouts are identified by the same reference numbers. One example of such a junction is the junction between the K line and the G line between the stations K9 and K10 in FIG. 3. For description purpose, the directions of travel are marked by arrows 806 and 808; however, the directions can be reversed as well. A magnet track 802 for the G line starts with an offset d from the lane center before the junction. The magnet track 802 turns and gradually moves to the lane center during the turn. An electronic guided bus on the G line will be guided to follow a trajectory 804 to transition from the magnet track 504 to the magnet track 802.

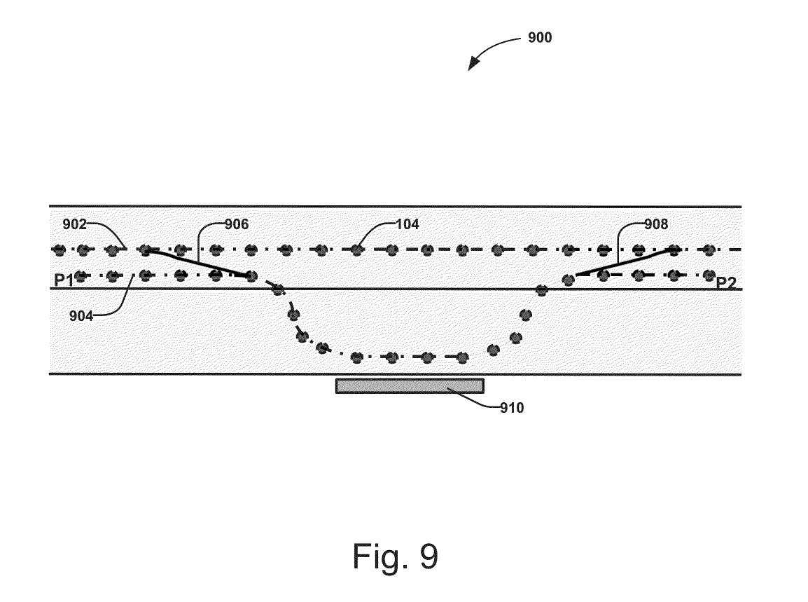

FIG. 9 shows a track layout 900 at a station 910 where an electronic guided bus can choose to dock at the station 910 or pass the station 910 without stopping. A docking magnet track 904 starts at a location point P1 before the station 910 and is parallel to a magnet track 902 with an offset. The docking magnet track 904 turns to the station 910 and then turns back to be parallel to the magnet track 902. The docking magnet track 904 ends at a location, P2, after the station 910. The electronic guided bus 102 that follows the magnet track 902 will be guided to follow a trajectory 906 to transition from the magnet track 902 to the docking magnet track 904. After docking at the station 910, the bus will be guided to follow a trajectory 908 to make the transition from the docking magnet track 904 back to the magnet track 902.

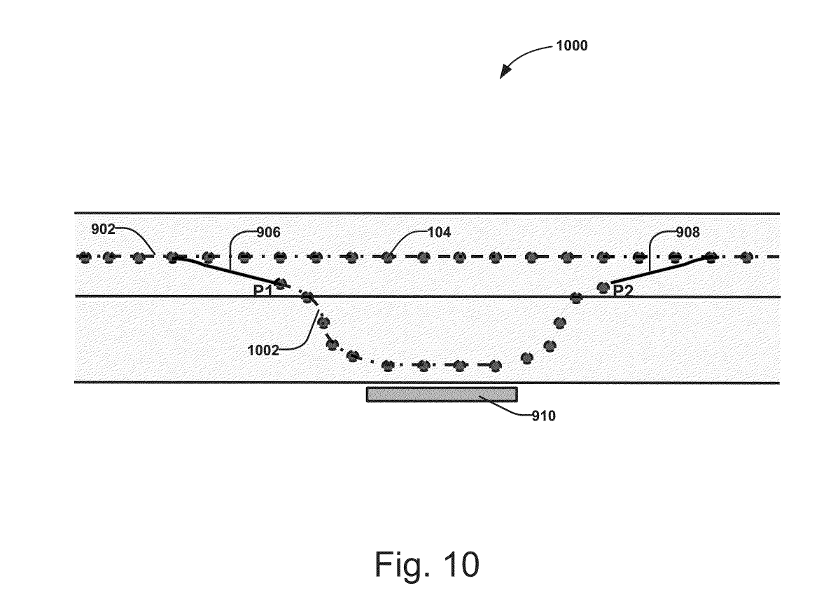

FIG. 10 shows an alternative track layout 1000 at the station 910, where like elements to other track layouts are identified by the same reference numbers. In this option, a docking magnet track 1002 starts at a location point P1 and ends at a location point P2, without the starting segment and the ending segment of the magnetic markers 104 that are parallel to the magnet track 902. In addition, the track layouts 900 and 1000 shown in FIG. 9 and FIG. 10 can be easily adopted at locations other than stations to allow a following bus to bypass a preceding bus that runs on the same magnet track.

FIG. 11 is a flowchart showing a process 1100 involved in one embodiment of the trip management method. The process 1100 can be run by the trip management module 406. Alternatively, the process 1100 can be run at a control center of the bus transit system and the result (i.e., the track being selected) can be communicated from the control center to the bus 102. In each processing cycle, the process 1100 starts with reading an assigned trip received by a communication unit (such as the module 404 in FIG. 4) from a control center in step 1102. The process 1100 then obtains junction information based on the assigned trip. In the embodiment shown in FIG. 11, the process 1100 obtains the junction information once at the beginning and then updates the junction information only when the assigned trip has changed. Accordingly, in step 1104 the process 1100 checks if the assigned trip has been changed, e.g., by comparing the newly received trip assignment with the currently stored trip assignment (from the last processing cycle). If the assigned trip has been changed, the process 1100 updates the junction information based on the newly received trip assignment in step 1106.

The junction information consists of a junction location and a desired track for each junction on the assigned trip. In one embodiment, the junction location is related to the magnetic marker number along the specific track. For example, for the Y line shown in FIG. 5, the junction location can be the marker number for the magnetic marker M1; that is, if the magnetic marker M1 is the 2000^{th} marker along the magnet track 502 for the Y line, the junction location is then 2000. The desired track for a junction can be defined by a sequential number representing the desired track's location among all tracks at the junction in a predefined direction, e.g., from left to right or from right to the left with the bus facing its travel direction. For example, the desired track for the junction shown in FIG. 5 is the magnet track 504, which is the first track from the right and the second track from the left. If the predefined direction is from right to left (or left to right), then the sequential number is 1 (or 2). Accordingly, the junction information for the junction shown in FIG. 5 is [2000, 1]. Thus, a junction table can be constructed for each trip as shown in Table 1, where each row corresponds to a junction, the first column represents the junction location, and the second column represents the desired track to be chosen (from right to left).

TABLE 1
Junction table

| Junction location | Desired track |
|---|---|
| 570 | 1 |
| 1245 | 2 |
| 2000 | 1 |
| 3420 | 3 |
| 4834 | 1 |

Subsequently, the process 1100 continues to step 1108 to obtain the current location of the bus 102. In one embodiment, the process 1100 directly gets the current location from the lateral control module 206 (FIG. 4). As described earlier, the magnetic markers 104 can be installed with either the north or the south polarity facing upward, and the sequence of the polarity forms codes that can be used to infer roadway information such as road curvature and mile posts (e.g., marker numbers). Thus, the position sensing unit 204 detects the polarity of the magnetic markers 104 and decodes the sequence of marker polarity to obtain the predefined codes. The position sensing unit 204 outputs the detected codes to the lateral control module 206, which determines the current location of the bus 102 based on the code. More specifically, the lateral control module 206 keeps track of the current marker number based on the most recently detected code and the magnets detected (and possibly distance traveled) since the most recently detected code.

Subsequently, the process 1100 continues to step 1110 to determine a current junction the bus 102 is at or approaching based on the current location of the bus 102 and the junction locations. For example, if the bus 102 is currently at marker 1800, it is still 200 markers away from the closest junction; thus, the process 1100 determines that the bus 102 is not at a junction. If the bus 102 is currently at a marker 104 whose marker number is between 2000 and 2000+N, where N is a pre-determined threshold (e.g., N=10), then the process 1100 determines that the bus 102 is at a junction (i.e., junction [2000, 1]) and the desired track corresponding to the identified (current) junction is 1 (the first track from the right) according to the junction table (Table 1).

If the process 1100 determines in the step 1110 that the bus 102 is not at a junction, the bus 102 simply follows its current track and the process exits to wait for the next processing cycle. If the process 1100 determines in the step 1100 that the bus 102 is at a junction, the process 1100 then continues to step 1112 to set the main track to be followed by the electronic guided bus 102 as the first track from the right according to the desired track for the identified junction. The process 1100 further outputs this main track to the lateral control module 206 in step 1114 and the lateral control module 206 determines the steering angle command necessary to follow this main track.

In a further embodiment, the process 1100 further generates a reference trajectory for the electronic guided bus 102 to transition to the main track; that is, the lateral control module 206 uses the reference trajectory to guide the bus 102 to gradually switch to follow the main track. The reference trajectory can consist of a series of offsets, representing the distance from the track the electronic guided bus 102 is currently following before the transition, and the lateral control module 206 will incorporate the reference trajectory to determine the desired steering angle. More specifically, the lateral control module 206 determines the steering command based on the offsets and the lateral deviation measured by the position sensing unit 204. For example, the array can be [0, 0.2*d, 0.4*d, 0.6*d, 0.8*d, 1.0*d] with the first value (0) corresponding to the junction location and each subsequent value corresponding to a subsequent magnetic marker. With this set of array, the electronic guided bus 102 will be guided to actually following the trajectory 510 to transition from the magnet track 502 (i.e., the current main track) to the magnet track 504 (i.e., the main track to be transitioned to). More specifically, before the junction location (marker M1), the bus 102 is guided to exactly follow the track 502. Starting from the marker M1, the lateral control module 206 will generate steering commands that actually guide the bus 102 to gradually shift towards the right of the magnet track 502 according to the offset array. Thus, at the marker (M1+5), the bus will be guided to a location with 1.0*d offset to track 502; such a location puts the bus 102 right on top the magnet track 504. At this point, the lateral control module 206 can then make the switch to follow this new main track (track 504), which is outputted by of the process 1100 in step 1114.

The process 1100 works with each of the layouts shown in FIGS. 5, 6, and 7 for the track layouts at a junction where two bus routes merge; however, the junction information and the reference trajectory will be defined differently for the different layout options. For the layout 500 in FIG. 5, the junction information is defined as [2000, 1] for this junction on the Y line and defined as [X, 1] (X represents a marker number) for this junction on the K line. For the layout 600 in FIG. 6, the junction information is defined as [2000, 2] for this junction on the Y line and [X, 2] for this junction on the K line because the desired track is now the second track from the right. For the layout 700 in FIG. 7, the junction information is the same as those for the layout 500 in FIG. 5 since the desired track is still the first from the right.

In one embodiment, the junction information may further include an offset representing the distance from the main track before the transition to the main track after the transition. For example, with the layout 500 in FIG. 5, the junction information would be [2000, 1, d]; with the layout 600 in FIG. 6, the junction information would be [2000, 2, 0] for the junction on the Y line and [X, 2, −d] for this junction on the K line. The process 1100 further determines the reference trajectory based on this offset.

Similarly, the process 1100 works with track layouts at a junction where two bus routes separate (as shown in FIG. 8) and at a station or an overtaken location (as shown in FIG. 9). The docking (and overtaking) scenario can be handled by two junctions, one before the station for the bus 102 to transition from the main line (track 902) to the docking track 904 and the other after the station for the bus 102 to transition back to the main line (track 902).

The process 1100 has been described to be run by the trip management module 406 on board an electronic guided bus. Alternatively, the process 1100 can be run by a computer at a control center of the bus transit system. This computer, referred to as the trip management computer, may be the same computer that generates the assigned trips for each bus, or it may communicate with the computer that generates the assigned trips. As each operating bus communicates its current location to the control center, the trip assignment computer gets the current location of each operating bus and runs the process 1100 for each operating bus. The trip assignment computer will then communicates the selected main track back to each operating bus, which follows the selected main track to carry out the assigned trip.

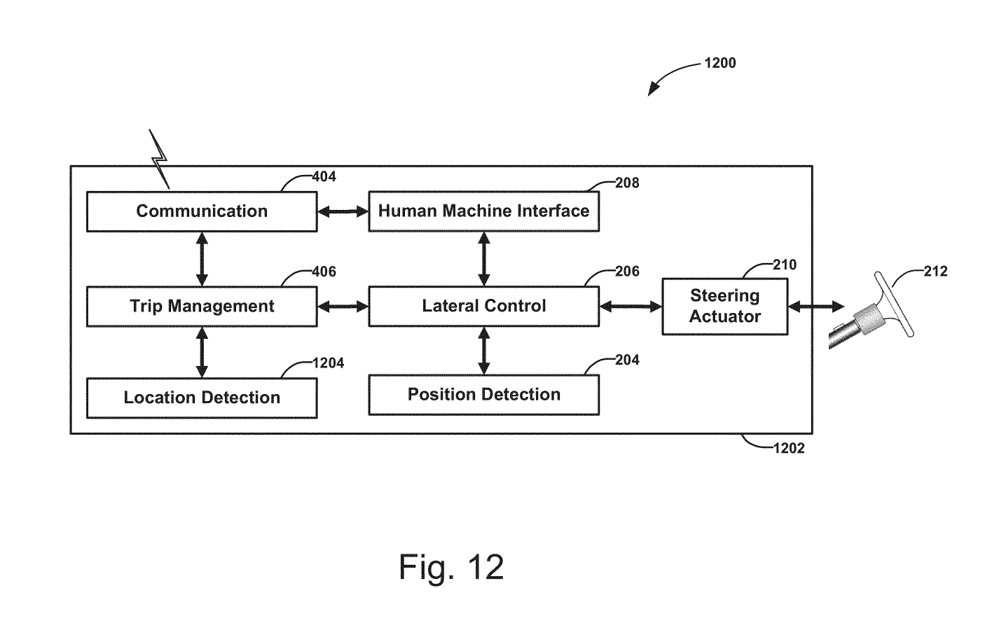

In a further embodiment, the electronic guided bus 102 is also equipped with a vehicle location detection device to detect its current location. FIG. 12 is a block diagram 1200 of another embodiment of the electronic guidance system with wireless communication and trip management for selecting tracks based on the assigned trip, where like elements to the system 400 are identified by the same reference numbers. In this embodiment, the trip management module 406 gets the current bus location from a location detection device 1204 instead of the lateral control module 206 (as described in the step 1108 in FIG. 11). For example, the location detection device 1204 can employ a satellite-based navigation system (such as Global Positioning System (GPS), GLONASS, and Beidou navigation system), which provides the bus location in longitude, latitude, and altitude coordinates. Differential stations can also be set up along the bus routes to provide differential signals to the location detection device 1204 to improve the accuracy of the bus location data. The location detection device 1204 can further convert the bus location into locally defined coordinates. Accordingly, the junction location will be defined in the same locally defined coordinates so that the bus location can be compared with the junction location to determine whether the bus 102 is at a junction in step 1110 (FIG. 11).

In another embodiment, radio beacons are mounted on top of utility poles at specific points along the bus routes, where the radio beacons send a low powered signal. The location detection device 1204 consists of a receiver that reads the low powered signal from the radio beacons when the bus 102 is passing the utility poles. Since each beacon has a unique ID, the location detection device 1204 can determine the bus location based on the last beacon crossed and the distance traveled, e.g., based on the odometer readings.

The trip management method has been described with the electronic guided buses using magnetic sensing techniques, but it can also work with electronic guided buses that employ vision-based or DGPS-based sensing techniques. Although there is no explicit track installed in the roadway, the vision-based or DGPS-based electronic guided buses still need to determine which lane or road to follow at junctions in order to carry out the assigned trips. For example, at a junction, the vision-based system will detect multiple lanes going towards different directions. By following the trip management process 1100, a vision-based electronic guidance bus can select the desired lane to follow based on the aforementioned junction table and carry out the assigned trip accordingly. For a DGPS-based electronic guidance bus, a digital map of the routes can be stored, and at a junction the bus can retrieve the corresponding digital map of the route segment by following the trip management process 1100 as well.

With regular buses, i.e., buses that are driven by human drivers on the assigned trips, the drivers determine where to go according to the assigned trip. Typically, an itinerary that includes all trips a driver needs to make is given to the driver (either on paper or displayed using the human machine interface 208). Whenever there is a real-time update, the driver will be notified through the human machine interface 208 and the driver then determines where to go accordingly. For an electronic guided bus, as described with the electronic guidance system 402 in FIG. 4 and the trip management process 1100 in FIG. 11, the wireless communication unit 404 receives the updates and passes the assigned trip to the trip management module 406. The trip management module 406 then automatically determines which magnet track 106 to follow at each junction according to the newly assigned trip without driver′ interference. This greatly eases the driver's workload, reduces human errors, and allows the driver to pay more attention to the passengers and services.

More importantly, this trip management capability allows great freedom for the dispatch center to dynamically define and update trips to maximize the transit systems capability in meeting ridership needs without increasing the workload of the drivers or the cost of transit operations. In other words, the transit system no longer needs to adhere to the traditional route in dispatching. Instead of defining trips using the traditionally fixed routes (such as the Y line or K line with a fixed origin and destination), trips can be defined flexibly using variable origins and destinations and across multiple fixed routes. For example, if a lot of people need to go from station R1 to station G3, a new trip can be defined with station R1 as the origin and station G3 as the destination, and the trip will include stations R1, R2, B2, K3, G4, and G3 and segments on the R line, B line, K line, and G line. The dispatch center can then select a bus and communicate this newly created trip to the selected bus. The selected bus receives the trip assignment via the communication unit 404 and the trip management module 406 automatically determines the main track to follow in order to carry out the trip based on the process 1100 in FIG. 11. Therefore, with the trip management capability of the electronic guided buses, it is desirable to have a trip planning method that estimates ridership demand and generates/updates trip arrangements (in real time) based on ridership demand to meet the riders' needs effectively while maximizing the transit's capability and efficiency.

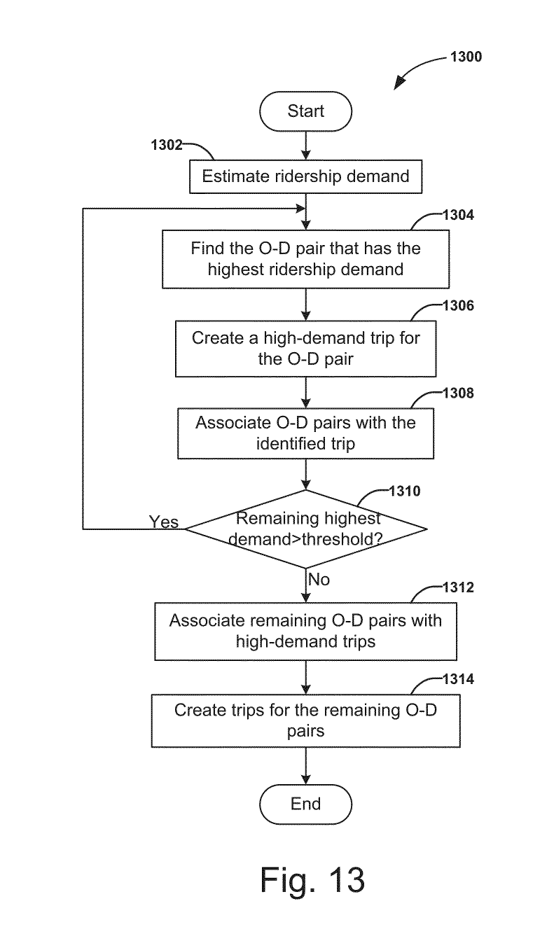

FIG. 13 is a flowchart showing a trip planning process 1300 involved in one embodiment of the trip planning method. The trip planning process 1300 could be run in one of the processors in a control center of a bus transit system. In one embodiment, the trip planning process 1300 can be run at any time to determine or generate the trip arrangements for a specified time period. In a preferred embodiment, the trip planning process 1300 is set to run at a per-defined processing cycle, e.g., every 5 or 10 or 15 minutes, as a real-time planning tool to evaluate and update the trip arrangements so as to better serve riders' needs within the transit's resources. In addition, the trip planning process 1300 can be triggered by events (such as a broken down bus or a crash) and thresholds (e.g., bad schedule adherences or changes in traffic conditions) to make arrangements to quickly handle those situations and resume normal transit operations.

The trip planning process 1300 starts with estimating the ridership demands in step 1302. In one embodiment, the trip planning process 1300 calls a ridership estimation process to estimate the ridership demands. The ridership estimation process can estimate the ridership based on the number of the passengers on board and historical ride demand information. In a further embodiment, the ridership estimation process also obtains and incorporates information about the origin and destination of the passengers into the estimation.

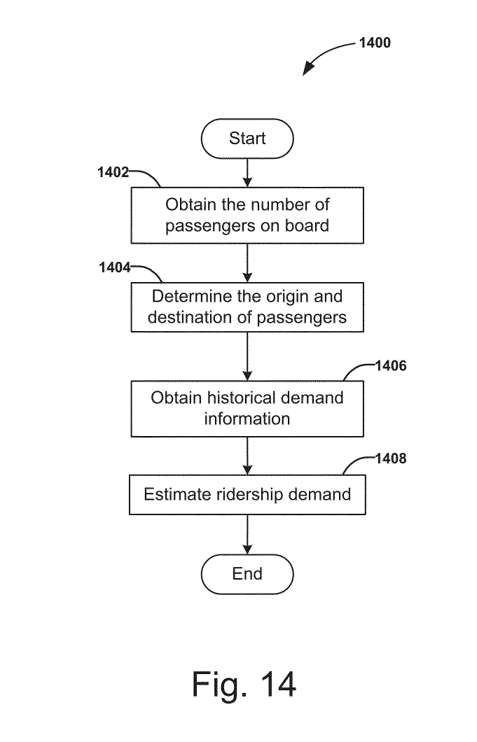

FIG. 14 is a flowchart showing such a ridership estimation process 1400. In step 1402, the ridership estimation process 1400 first obtains the number of the passengers on board the buses 102. The number of the passengers on board the buses 102 can be tracked in real time by automated passenger counters (APC) as well as electronic fare boxes. The APC are a well-known automated means of collecting data on the passengers as they board and alight from the bus 102 by time and location. Infrared beams and treadle mats are the two most common technologies. The former involves placing two infrared beams across a passenger's path; as the passengers board and alight from the bus 102, they interrupt the beam in a particular sequence, thus activating the APC device. The latter involves placing two treadle mats on the steps of doorway and the pressure of the passengers stepping on them activates the APC. The electronic fare payment systems employ electronic communication, data processing and data storage techniques to eliminate cash/coin handling and automate accounting. Therefore, they also provide a capability for counting boarding and off-boarding. In addition, cameras can also be employed to count the boarding and off-boarding of the passengers. This information is then communicated from the buses 102 to the control center of the transit system.

In step 1404, the ridership estimation process 1400 further determines the origins and destinations of the passengers. The real-time determination of the origin of a passenger can be determined by where the passenger boards the bus 102. The real-time determination of the destination of a passenger can be determined with devices that allow the passengers to register their destination. For example, the human machine interface 208 on-board the buses 102 may be accessible to the passengers for them to select their destinations and the buses 102 communicate this information to the control center. Moreover, the ticket vending machines at the stations 304 can report to the control center the origin and destination for each ticket issued. The transit system may also provide mobile device applications that allow the riders to set their origins and destinations for trip planning, and this information is sent to the control center as well.

Both the information above can be gathered in real time while the real-time information gathered in the past becomes the historical information about ridership demand. Moreover, the stations 304 where the passengers get off of the buses 102 can be obtained (e.g., via APC) to provide more accurate records of the destinations in the historical ridership information. This historical ridership information (including the corresponding time) will be stored in a memory at a data server, e.g., the same server that runs the trip planning and the ridership estimation processes. Thus, in step 1406, the ridership estimation process 1400 obtains the historical ridership demand corresponding to the specific time period of interest (typically the current time for real-time estimation).

Subsequently in step 1408, the ridership demand is estimated based on the number of the passengers, the origins and destinations, and the historical ridership demand obtained in the steps 1402 to 1406. Various modeling tools can be applied in the estimation and the demand for any specific origin and destination pair during a specific time of the day can be determined. Various modeling tools for this specific purpose are well-known to those skilled in the art and need not be described in detail here. Thus, the estimated ridership demand can be represented by a list of origin-destination pairs and their corresponding number of the riders. Alternatively, a simpler estimation of ridership demand can also be represented by a list of stations and for each station the number of the riders who get on or off a bus at this station.

With the ridership demand estimated in the step 1302, the trip planning process 1300 then generates trip arrangements so as to reduce the trip time, waiting time at stations, and the number of connections for riders while maximizing the transit efficiency. In one embodiment, the determination of trip arrangements is performed in steps 1304 to 1314. The process 1300 first finds the origin-destination pair, stations O1-D1, which has the highest ridership demand in the step 1304. Subsequently in step 1306, the process 1300 identifies a trip, T-O1-D1, with station O1 as the origin and station D1 as the destination, which has the shortest trip completion time. Typically, this trip T-O1-D1 is likely to be the shortest trip from station O1 to station D1. In step 1308, the trip planning process 1300 identifies all the stations in the trip T-O1-D1 and associates all the origin-destination pairs whose origin and destinations are among those stations with the trip T-O1-D1. The trip planning process 1300 may further compute a weighted ridership demand for the trip T-O1-D1 based on the ridership demand for all these origin-destination pairs that are associated with this trip. The process 1300 then checks if the highest ridership demand in the remaining origin-destination pairs is larger than a threshold in step 1310. If so, the process 1300 continues the loop from the step 1304 to the step 1308 to identify the next trip. If not, the process 1300 continues to the step 1312 to process the remaining origin-destination pairs that have relatively low demand. For description purpose, the trips that are created in the step 1306, e.g., trip T-O1-D1, are referred to as high-demand trips. Thus, through the steps 1304 to 1312, the trip planning process 1300 creates high-demand trips based on origin-destination pairs that have high ridership demand.

The trip planning process 1300 then associates origin-destination pairs with high-demand trips in the step 1312. For each of the remaining low-demand origin-destination pairs, the process identifies two or more high-demand trips whose stations and directions match those of the low-demand origin-destination pair. For example, a low-demand origin-destination, station O3-D3, can be associated with two high-demand trips, trip T-O1-D1 and trip T-O2-D2, if the origin station O3 is a station in trip T-O1-D1 and the destination station D3 is a station in trip T-O2-D2 and if the direction from station O3 to station D3 is the same direction of station O1 to station D1 and station O2 to station D2. If these two trips have overlapping stations, then no new trip needs to be created for the low-demand origin-destination, stations O3-D3, since the riders can take those two high-demand trips with one connection between them to go from station O3 to station D3. In some cases, the two high-demand trips may not have overlapping stations, and the process will need to find a third high-demand trip that connecting those two trips together.

If there are still origin-destination pairs remaining (i.e., not associated) after the step 1312, those origin-destination pairs must have an origin or a destination not covered by any high-demand trips. Typically, those origins or destinations are the terminals at the end of a route. For these low-demand origin-destination pairs, the process 1300 further creates low-demand trips by extending high-demand trips to their origins and destinations in step 1314. The process 1300 does so by finding a high-demand trip whose origin is closest to the origin of the low-demand origin-destination pair and a high-demand trip whose destination is closest to the destination of the low-demand origin-destination pair. The process 1300 then creates two new trips by extending the identified high-demand trips to cover the origin and destination of the low-demand origin-destination pair. For example, for a low-demand origin-destination pair is stations O4-D4, and the process finds that among all of the origins of the high-demand trips station O5 is the closest station to station O4 and among all the destinations of the high-demand trips station D6 is the closest station to station D4. Thus, the two high-demand trips found are T-O5-D5 and T-O6-D6. Typically these two high-demand trips either have overlapping stations 304 for transfer or overlap with a third high-demand trips for transfer. Thus, the process 1300 creates two new trips T-O4-D5 and T-O6-D4. And the demands of these two trips inherit the low-demand for the origin-destination pair station O4-D4 such that longer service interval will be assigned to these two trips.

Thus, trips that cover all origin-destination pairs are created, and faster trips are assigned to the origin-destination pairs that have higher ridership demand. The process 1300 may adjust the threshold used in the step 1310 to control how many individual high-demand trips are generated. Alternatively, the process 1300 may set a threshold on the number of high-demand trips and use it in the step 1310 to determine whether to continue creating high-demand trips through the steps 1304 to 1308 or to go to the step 1312.

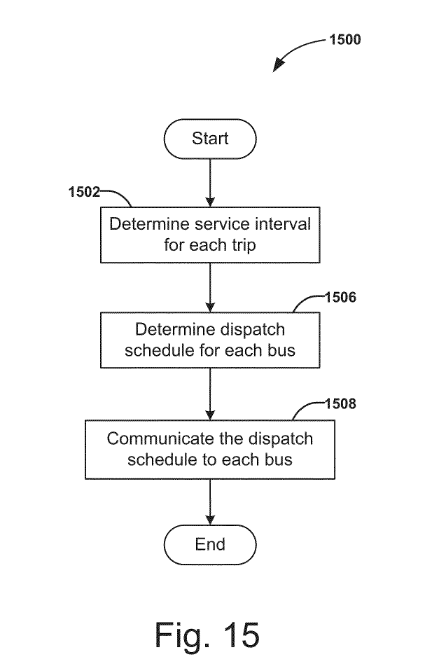

The generated trip arrangements can then be used by a dispatch process, which generates the dispatch schedule for the trips, assigns the trips to individual buses and communicates the assigned trips to individual buses. FIG. 15 is a flowchart showing a dispatch process 1500 involved in one embodiment of a dynamic dispatch method for dispatching buses for a bus transit system based on ridership demand. The dispatch process 1500 can work with traditional trip planning where the trips are fixed, e.g., typically routes such as the R line, Y line, and K line in FIG. 3. However, when working with real-time trip planning such as the process 1300, the dynamic dispatch process 1500 can realize its advantages of better meeting riders' demand and maximizing transit efficiency.

The dynamic dispatch process 1500 starts with determining the service interval for each trip in step 1502. When working with traditional trip planning, the trips are fixed routes. In a preferred embodiment, the trips are created by the trip planning process 1300 based on ridership demands and transit recourses. In one embodiment, the determination of the service interval of a trip further comprises four sub-steps: (1) estimating ridership demand for the trip, (2) computing a trip completion time, (3) allocating a number of buses for the trip, and (4) determining the service interval of the trip based on the ridership demand, the trip completion time, and the number of buses allocated for the trip.

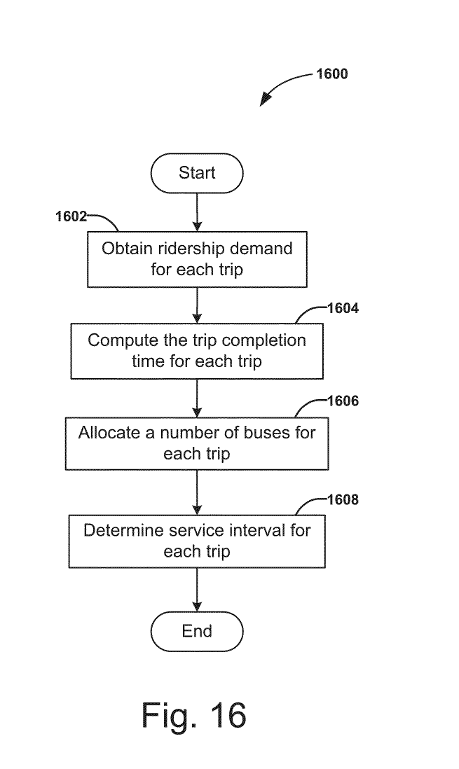

FIG. 16 is a flow chart showing a ridership estimation process 1600 for these four sub-steps that the dispatch process 1500 takes to determine the service interval for each trip. In step 1602, the ridership demand for each trip is obtained or estimated. If the trip arrangements are generated by a trip planning process such as the process 1300, the ridership demand for each trip is then already determined in the trip planning process in the step 1308 and is readily available for use. Thus, the ridership demand is obtained in the step 1602. If the trips are fixed routes, the ridership demand can be estimated based on the number of passengers on board, the origin and destination of the passengers, as well as historical ridership information, as shown in the ridership estimation process 1400 (FIG. 14). Thus, the step 1602 employs the ridership estimation process 1600 to estimate the ridership demand. The estimated ridership demand can be represented by a list of origin-destination pairs and their corresponding number of riders. Thus, the ridership demand for a trip can be a function (e.g., a weighted sum) of the numbers of the riders corresponding to all origin-destination pairs that are in the trip. Alternatively, a simpler estimation of ridership demand can be represented by a list of stations and for each station the number of the riders who get on or off a bus at this station. Thus, the ridership demand for a trip is then a function (e.g., a weighted sum) of the numbers of the riders corresponding to all stations in the trip.

Subsequently, in step 1604, the trip completion time is estimated based on historical data as well as the current traffic condition on the segments involved in a trip. The current traffic condition can be estimated based on the speed of the buses on the (nearby) segments, where the speed is either directly communicated from the buses or derived from the bus locations. The current traffic condition may also be obtained from sources such as web-based traffic information, traffic sensors (including cameras), as well as mobile devices (such as mobile phones).

In step 1606, the dispatch process 1500 determines the number of the buses 102 (and the type of buses) needed for each trip based on the estimated ridership demand and the trip completion time. Typically, a transit system may have multiple different types of buses and the dispatch process 1500 also determines the type of the buses 102 for each trip. For example, a high-capacity bus (e.g., a 60-ft articulated bus) is likely assigned for a high-demand trip while a low-capability bus (e.g., a minibus) is typically assigned for a low-demand trip. Also in the step 1606, the dispatch process 1500 takes into consideration of the available buses and drivers, as well as operation rules related to the operational safety (e.g., interlocking) and the capability of the routes.

Finally in step 1608, the dispatch process 1500 determines the service interval for each trip based on the estimated ridership demand, the trip completion time, and the number of buses allocated for the trip. Since the ridership demand and the trip completion time vary depending on the time of the day, the service interval is likely to vary during a day as well.

Subsequently, the dispatch process 1500 continues to step 1506 to determine a dispatch schedule for each bus. More specifically, the schedule for each trip is first determined based on the service interval as well as timed arrivals at transfer stations among trips. Subsequently, each trip is then assigned to a specific bus according to its scheduled time; where the location of the buses 102 may also be taken into consideration in the trip assignment. Thus, multiple trips are assigned to a bus and the dispatch schedule for each bus consists of the trips for the bus and the schedule of these trips.

Subsequently in step 1508, the dispatch process 1500 communicates the generated dispatch schedule to each bus. The communication unit 404 on the bus receives the dispatch schedule and provides it to the driver via the human machine interface 208. In the case that the bus is an electronic guided bus 102, the communication unit 404 receives the dispatch schedule and passes it to the trip management 406, which then determines the track to follow to carry out each specific trip. The dispatch schedule may also be displayed to the driver via the human machine interface 208 such that the driver can monitor the operation of the electronic guided bus 102.

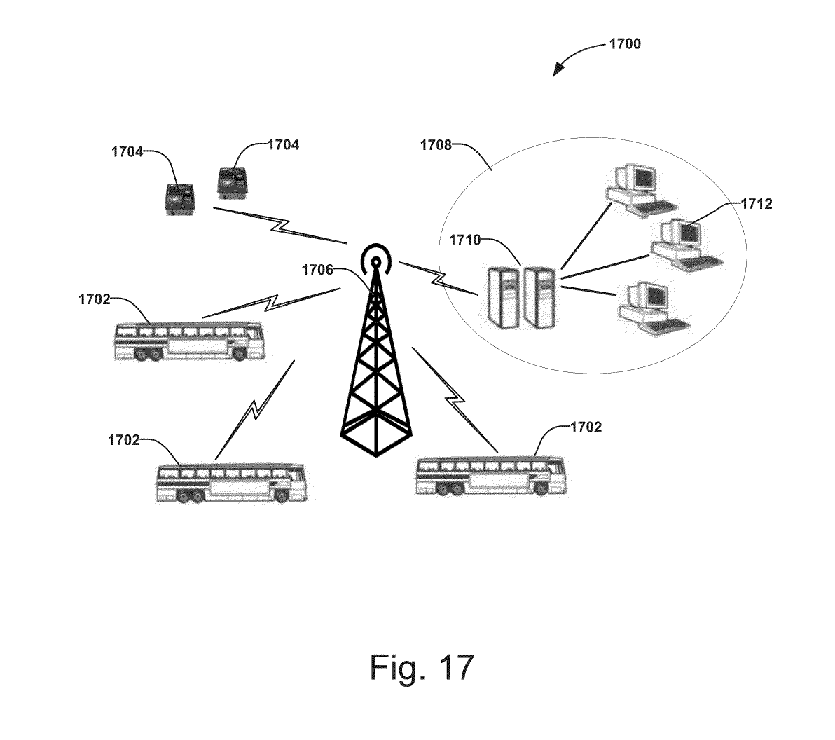

With the trip management method and the trip planning method, an intelligent transit system can be developed with electronic guided buses. FIG. 17 is a schematic illustration of an intelligent transit system 1700 that comprises a plurality of electronic guided buses 1702, a plurality of ridership tracking devices 1704 for obtaining passengers' trip information, at least one communication devices 1706 (typically installed on some road infrastructure), and a control center 1708 with at least one dispatch processor 1710. The control center 1708 may also have terminals 1712 (including displays and keyboards) for interfacing with transit personnel.

Each electronic guided bus 1702 is equipped with an electronic guidance system for receiving an assigned trip from the dispatch processor 1710 via the communication devices 1706 and automatically steering the bus 1702 to carry out the assigned trip. One embodiment of such an electronic guidance system is the system 400 shown in FIG. 4 as described above. Typically, the lateral control module 206 keeps track of the marker number of the most recently detected marker by updating the marker number based on the most recently code and increasing the marker number for each magnetic marker 104 detected after the code. The wireless communication unit 404 communicates the current location of the electronic bus (together with a time stamp) to the control center 1708 via the communication device 1704. In another embodiment, the electronic guided bus 1702 is equipped with the vehicle location device 1204 (e.g., a satellite-based navigation system) to detect the current location of the bus location and the communication unit 404 communicates this current location to the control center 1708.

In one embodiment, the trip management module 406 runs the trip management process 1100 as shown in FIG. 11 to determine the magnet track 106 to follow based on the assigned trip. The trip management module 406 first obtains the junction information based on the assigned trip (received by the communication unit 404). This junction information includes a junction location and a desired track for each junction on the assigned trip; where the desired track 106 for a junction can be defined by a sequential number representing the desired track's location among all tracks at the junction in a predefined direction (e.g., from left to right or from right to left). The trip management module 406 then obtains the current location of the electronic guided bus 1702, e.g., from the lateral control module 206 or from the vehicle location detection device 1204. Based on the current location of the bus 1702 and the junction information, the trip management module 406 determines whether the bus 1702 is in or approaching a junction and, if so, identifies the junction the bus 1702 is at. The trip management module 406 then sets the magnet track 106 for the bus 1702 to follow based on the desired track for the identified junction.

In a further embodiment, the trip management module 406 generates a reference trajectory, which consists of a series of offsets representing the distance from the track 106 the electronic guided bus 1702 is following before switching to the main track (i.e., the desired track at the junction). The lateral control module 206 incorporates this reference trajectory to determine the desired steering angle such that the electronic guided bus 1702 is guided smoothly to transition from one magnet track to another magnet track. More specifically, the lateral control module 206 determines the steering command based on the offsets and the lateral deviation measured by the position sensing unit 204. Thus, the electronic guided bus 1702 is guided to follow the reference trajectory, which is offset to the magnet track before transition and smoothly connects to the magnet track 106 after transition (as described with FIGS. 5, 6, 8, 9 and 10).

The ridership tracking devices 1704 collect information related to ridership demand. As described in the ridership estimation process 1400 (in FIG. 14), the ridership demand can be estimated based on the number of the passengers, the origins and destinations of the passengers, and the historical ridership demand. Thus, embodiments of the ridership tracking devices 1704 include APC (automated passenger counters), electronic fare boxes, video-based passenger counters, ticket vending machines, as well as mobile devices with transit applications for riders' trip planning.

In one embodiment, the ridership tracking devices 1704 comprise a plurality of passenger counting devices, each on board the electronic guided bus 1702 for counting the passengers as they board and alight from the bus 1702. It is further connected to the communication unit 404 of the electronic guidance system for communicating passenger counts (together with the location of the bus and time stamps) to the control center 1708. In another embodiment, the ridership tracking devices 1704 comprise electronic fare boxes, each on board the electronic guided bus 1702 for counting the passengers on board. They may also allow the passengers to input their destination. Each electronic fare box is also connected to the communication unit 404 for communicating the passenger information (counts, origins and destinations) to the control center. In another embodiment, cameras are installed on the electronic guided buses 1702 and video signal processing is used to extract the number of the passengers as they board and alight from the bus 1702. This information is then provided to the communication unit 404, which communicates the information to the control center 1708.

In another embodiment, a plurality of electronic fare boxes are installed at the stations 304 for counting the passengers entering and existing the stations 304 as they collect fare from the electronic tickets of the passengers. These electronic fare boxes are connected to and output the passenger information to communication devices 1706 at the stations. The communication devices 1706 then communicate such information to the control center 1708. In addition, ticket vending machines at the stations 304 can report the origin and destination for each ticket issued to the control center 1708 via the communication devices 1706 as well. When both electronic fare boxes and ticket vending machines are used at the same station, it is necessary to avoid double counting of a single ticket. As these tickets are typically electronic tickets with unique ID codes (or bar codes), the double counting can be avoided by comparing the ID code so as to exclude tickets that have been counted already.

Thus, the communication device 1706 receives the passengers' trip information from the ridership tracking devices 1704 and passes the information to the dispatch processor 1710 at the control center 1708. The dispatch processor 1710 then estimates ridership demands based on the passengers' trip information, determines a plurality of trips based on estimated ridership demands, generates dispatch schedule for the trips, assigns trips to the electronic guided buses 1702, and communicates assigned trips to the electronic guided buses 1702 via the communication device 1706.

More specifically, the dispatch processor 1710 uses the passengers' trip information (e.g., passenger count number, time, and location) as real-time ridership information and also stores it to be used as historical ridership information later. Subsequently, the dispatch processor 1710 runs a trip planning process (such as the process 1300 shown in FIG. 13) to estimate real-time ridership demands based on the received real-time passengers' trip information and the historical ridership information and to determine trip arrangements based on the estimation of ridership demands. As shown in FIG. 14, the ridership demand can be estimated by obtaining the number of the passengers on board the buses 1702, determining origins and destinations of passengers, obtaining historical ridership demands, and estimating ridership demand based on the number of the passengers, the origins and destinations, and the historical ridership demand. As shown in FIG. 13, the plurality of trips can be determined based on estimated ridership demands by creating high-demand trips based on origin-destination pairs that have high ridership demand; associating origin-destination pairs with high-demand trips, and creating low-demand trips by extending high-demand trips to origins and destinations of low-demand origin-destination pairs.

The dispatch processor 1710 further runs a dispatch process (such as the process 1500 shown in FIG. 15) to determine the schedule for each trip based on the ridership demand as well as trip completion time and available buses, assign each trip to an electronic guided bus 1702, and communicates the assigned trip and the corresponding schedule to the electronic guided buses 1702 via the communication device 1706.

Although described with electronic guided buses based on magnetic sensing techniques, the intelligent transit system can also work with electronic guided buses that employ vision-based or DGPS-based sensing techniques. The intelligent transit system 1700 has great advantages. With the real-time ridership demand estimation and the real-time trip arrangements based on ridership demand, this intelligent transit system can effectively meet the riders' needs while maximizing the transit's capability and efficiency. Meanwhile, with the on-board trip management capability, the electronic guided buses 1702 can dynamically update or determine the track 106 to follow so as to automatically carry out the assigned trip without increasing the workload of the drivers. Such on-board trip management capability allows great freedom for the transit dispatch center to dynamically define and update trips so as to maximize the transit′ capability in meeting ridership needs without increasing the cost of transit operations.

Furthermore, as the electronic guided buses 1702 can provide rail-like performance such as accurate lane keeping and precision docking capabilities, it is an unique advantage to dispatch the electronic guided buses 1702 in a way such that the buses 1702 started at different origins can form groups as they enter the shared segments and then separates for their different destinations. This novel operation allows multiple buses of different trips to dock at a station at the same time like a train with multiple units, providing greater connectivity between origins and destinations while minimizing waits for the riders.

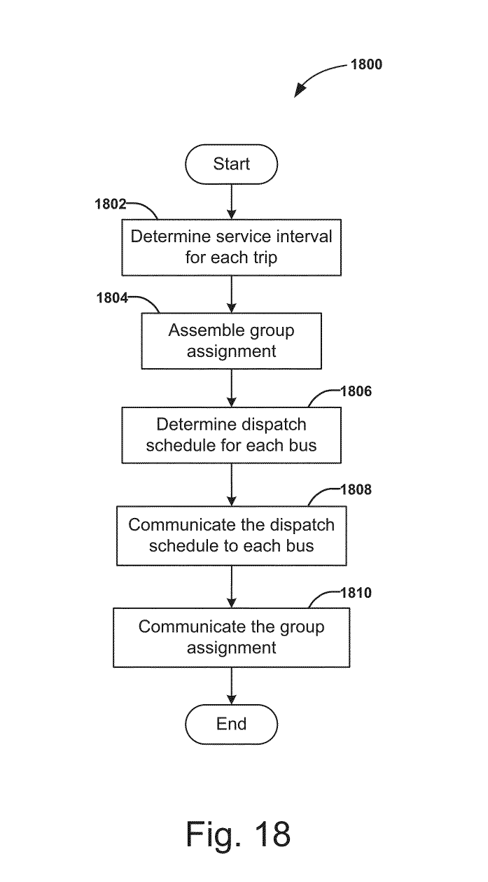

FIG. 18 is a flowchart showing a dispatch process 1800 involved in one embodiment of a dispatch method for dispatching buses in groups for a bus transit system. The process 1800 can be run at any time as a planning tool to determine the service intervals, group assignments, and dispatch schedules for a specified time period. In a preferred embodiment, the process 1800 is set to run at a predefined processing cycle, e.g., every 5 or 10 or 15 minutes, as a real-time planning tool to update the service intervals, group assignments, and dispatch schedule in real time. In addition, the process 1800 can be triggered by events (such as a broken down bus or a crash) and thresholds (e.g., bad schedule adherences or changes in traffic conditions) to make arrangements to quickly handle those situations and resume normal transit operations.

The dispatch process 1800 starts with determining a service interval for each trip of the bus transit system in step 1802. In one embodiment, each trip corresponds to a fixed route of the bus transit system such as the R line or K line shown in FIG. 3. In a preferred embodiment, the trip planning process 1300 (FIG. 13) is run to determine trip arrangements based on the ridership demand, which provides the flexibility of creating trips not limited by the fixed routes to better meet the ridership demand. In the step 1802, the dispatch process 1800 takes the four-step process 1600 in FIG. 16 to determine the service interval for each trip based on the ridership demand, the trip completion time, and the number of the buses 1702 allocated for the trip.

After determining the service interval for each trip in the step 1802, the dispatch process 1800 continues to step 1804 to determine group assignments. Each group assignment assigns a plurality of the buses 1702 into a group on a segment shared by the plurality of the buses 1702. The group assignment could be for a whole trip, especially for trips with high ridership demands. By assigning multiple buses in a group, the buses 1702 in a group would be more like a train with multiple units, which can greatly increase the transportation capacity of a bus transit system. The group assignment could also be for a part of a trip. For example, if a large number of passengers need to go from station R1 to station K9 while a large number of passengers need to go from station R1 to station G2 (in FIG. 3), two buses can be dispatched in a group from station R1 and then separates after station K3 with one going towards station K9 and the other going towards station G2. Thus, the determination of the group assignment comprises (1) identifying sets of trips that have shared segments and could be assigned together, and (2) determining at least one group assignment for each set of trips (that have shared segments) based on the service interval of each trip in the set. In a further embodiment, the determination of group assignment further includes determining a position in the group for each of the buses that carry out the group assignments.

With the example above, the dispatch process 1800 would identify the trip from station R1 to station K9 (referred to as trip T1) and the trip from station R1 to station G2 (referred to as trip T2) as a set of trips that have shared segments and could be assigned together. The dispatch process 1800 then compares the service intervals for these two trips to determine how often these two trips should be grouped together. For example, if trip T1 has a service interval of 5 minutes and trip T2 has a service interval of 10 minutes, these two trips should be grouped together every 10 minutes. As the service interval for each trip could change depending on the time of the day, the group assignments will also vary accordingly.

The dispatch process 1800 could then assign the bus for trip T1 as the lead bus in the group and the bus for trip T2 as the first following bus in the group or vice versa. Since these two trips share segments at the beginning portion, the position of the buses in the group may not be critical. However, for two trips that share segments in the middle, the determination of the position of the buses may need to take into consideration of time to the shared segments and preferred sequence of joining a group. For example, it may be desired to position a third bus, which needs to join a group currently consisting of two buses, as either the lead bus or the second following bus at the end of the group instead of having this third bus joining in between the two buses that are already in the group.

It is important to point out that a trip may have shared segments with multiple different trips. For example, the trip T1 also shares segments with another trip T3, which is from station Y1 (i.e., station R5) to station Y14, although the trip T2 does not share any segments with trip T3. Thus, the trip T1 may be grouped with trip T3 as well. Thus, a bus carrying out trip T1 could start in a group with a bus carrying out trip T2, then separate from that group in the segment between station K3 and station K4, and forms a group with a bus carrying out trip T3 in the segment between station K4 and station K5.

Thus, the determined group assignment can be organized per each trip. In other words, each trip then has its associated group assignment and the bus that is assigned to carry the trip will carry out the group assignment as well. In one embodiment, the group assignment information for each bus in a group comprises a list of segments and the position of the bus for each segment. For example, the group assignment for trip T1 can be represented by a table, such as Table 2 below. The first column of the table lists the shared segments and the second column of the table lists the position of the bus that carries out the trip. The segments that are not included in the table are the segments where the bus operates as a single bus.

TABLE 2
Group Assignment Table

| Segment | Bus position |
|---|---|
| R1~R2 | 1 |
| R2~B2 | 1 |
| B2~K3 | 1 |
| K4~K5 | 2 |
| K5~K6 | 2 |
| K6~K7 | 2 |

In another embodiment, the group assignments are represented by the locations where the group assignment changes. Then the group assignment for trip T1 can be represented by the table such as Table 3 below. Junction1 refers to the junction where the G line separates from the K line between stations K3 and K4, Junction2 refers to the junction where the Y line merges with the K line between stations K4 and K5, and Junction3 refers to the junction where the Y line separates from the K line between stations K7 and K8.

TABLE 3
Group Assignment Table

| Start location | End location | Bus position in group |
|---|---|---|
| R1 | Junction1 | 1 |
| Junction2 | Junction3 | 2 |

Based on the service intervals determined in step 1802 and the group assignments determined in the step 1804, the dispatch process 1800 then determines a dispatch schedule for each bus in step 1806. More specifically, the schedule for each trip is first determined based on the service interval and group assignment such that the buses (that carry out the trips) in a group can arrive at the shared segments almost simultaneously to form the group. Subsequently, each trip is assigned to a specific bus according to its scheduled time. Thus, multiple trips are assigned to a bus and the dispatch schedule for each bus consists of the trips for the bus and the schedule of these trips.

Subsequently in step 1808, the dispatch process 1800 communicates the generated dispatch schedule to each bus. The communication typically involves sending the digitized dispatch schedule from the dispatch processor 1710 at the control center 1708 to the communication device 1706, which then communicates the information to the bus. The communication unit 404 on the bus receives the dispatch schedule and provides it to the driver via the human machine interface 208. In the case that the bus is an electronic guided bus 1702, the communication unit 404 receives the dispatch schedule and passes it to the trip management module 406, which then determines the track 106 to follow to carry out each specific trip. The dispatch schedule may also be displayed to the driver via the human machine interface 208 such that the driver can monitor the operation of the electronic guided bus 1702.

Further in step 1810, the dispatch process 1800 communicates the group assignment information to each bus that would be in a group in any of its trips. If the bus speed is controlled by a driver, the group assignment information will be displayed to the driver via the human machine interface 208 and the driver will control its speed to coordinate with other buses to form a group or separate from a group accordingly. If the bus is equipped with an electronic guidance system that further includes longitudinal control module to control the bus's speed, the electronic guidance system will then control the bus speed automatically to coordinate with other buses to form a group or separate from a group according to the group assignment.

As described earlier, in one embodiment, the dispatch process 1800 is run periodically at predefined (fixed or preferably variable) cycles as well as at specific instances when trigged by events (such as a broken down bus or crashes) and thresholds (e.g., bad schedule adherence). In every process cycle, the dispatch process 1800 can then incorporate real-time information, such as the real-time ridership demand, the real-time traffic condition, as well as the real-time locations of all operating buses, into its processing or decision making More specifically, in the step 1802, the dispatch process 1800 determines or updates the service intervals of each trip by estimating the ridership demand for the trip in real time, computing a trip completion time based on real-time traffic conditions, updating the number of buses for the trip in real time, and then updates the service interval of the trip based on the real-time ridership demand, the real-time trip completion time, and the number of buses for the trip. The goal is to reduce the trip time, waiting time at stations, and the number of connections for riders while maximizing the transit efficiency (e.g., increasing bus occupancy and reducing traveling distances for buses).

In another preferred embodiment, the dispatch process 1800 estimates the ridership demand in real time in the step 1802; subsequently, the dispatch process 1800 also evaluates the trip assignment and modifies trip assignment for at least one bus in real time according to the estimated ridership demand. For example, if the real-time ridership demand shows that the number of the passengers going from station R1 to station G2 (i.e., trip T2) is decreasing while a large number of the passengers going from station Y13 to station G14 are emerging. The process 1800 then creates a new trip T4 with station Y13 as the origin and station G14 as its destination. Also based on the ridership demand, the process 1800 can increase the service interval for trip T2 (as its riders are decreasing). If the number of the passengers going from station R1 to station G2 gets small enough, the process 1800 then cancels trip T2 entirely. In one embodiment, the dispatch process 1800 incorporates the trip planning process 1300 to evaluate and updates trip assignments in real time.

After the trips and the service intervals are updated in the step 1802, the process 1800 further updates the group assignment (i.e., modifies the group assignment) based on the updated, real-time service interval in the step 1804. Alternatively, the process 1800 may directly update or modify the group assignment based on the estimated real-time ridership demand directly. For example, if the ridership demand for a trip has increased sharply, the process 1800 can directly create a new group to dispatch two buses (instead of one bus) at the same time for the whole trip to meet the increased ridership demand. The process 1800 may also incorporate the real-time locations of the buses in updating the group assignment. That is, the dispatch process 1800 may further receive the current location of the buses 102 in real time and update the group assignments in real time based on the location of buses. For example, if two trips, trip T5 and trip T6, share segments but were originally scheduled such that the two buses carrying out these two trips would not be at a shared segment at the same time, these two trips were then not assigned into one group. However, if the bus carrying out trip T6 is running late such that the two buses are now indeed operating close to each other, the process 1800 can then create a new group assignment to command the two buses to form a group. Upon receiving the group assignment, one bus slows down a little bit and the other bus speeds up a little bit to meet each other and form the group. By doing so, these two buses arrive at the stations 304 on the shared segments at the same time to facilitate transferring passengers and to smooth out the traffic flow since the two buses are now acting like one unit.

As the above example shows, the modification of the group assignments includes creating a new group assignment. It could also include cancelling a group assignment (e.g., if two buses that were assigned in a group become too far away to form a group), dissolving an existing group assignment (e.g., if the ridership demand causes a trip to be modified), and so on.

As the trips and service intervals are changed in the step 1802, the group assignment determined in the step 1804 and the dispatch schedule determined in the step 1806 will be changed accordingly. As a result, some buses that have been dispatched to carry out certain trips may be reassigned to a different trip in real time. As the dispatch process 1800 communicates to the bus the updated dispatch schedule in the step 1808 and the updated group assignment in the step 1810, some buses will be notified to change their trips and head to a different destination in real time to better meet the real-time ridership demands. Upon receiving such changes, the bus's driver or the bus's on-board system will notify the passengers on the bus such changes and provide advisory information for them to make transfers. Although some of the passengers may need to make more transfers, the overall service quality and transit efficiency will be improved as much more riders' needs are satisfied with shorter trip time and reduced wait time.

In a further embodiment, the dispatch process 1800 further generates a station-bypass command for a station on a trip, selects a bus on the trip to execute the station-bypass command, and communicates the station-bypass command to the selected bus. Such a station-bypass command is generated for stations in low demand and the dispatch process 1800 evaluates whether a station is in low demand based on an estimated ridership demand for the station 304 and the number of services the station 304 receives. The ridership demand of a station is determined based on how many riders have trips with this station as either the origin or the destination as well as how many riders use this station for transfer if the station is also a transfer station. The number of services a station receives is determined based on the number of trips that cover this station and the service interval of each of these trips.

If a station is in low demand compared to the number of services it gets, the dispatch process 1800 reduces the number of services by selecting a number of trips to go through this station without stopping. The dispatch process 1800 then generates a station-bypass command for this station and communicates the station-bypass command to the buses that carry out the selected trips. After receiving this station-bypass command, the selected buses will then pass the specified station without stopping. The station-bypass command is typically issued at least several stations in advance so that the selected buses can notify passengers in advance and provide advisory information to the passengers who are going to the specified station for them to make the proper transfer. Typically, those passengers are advised to get off at a station earlier and take a next bus that does stop at that specific station. As the selected buses can complete a trip in a shorter time and better serve a large number of passengers, the overall service quality and transit efficiency are improved.

In addition, changes or updates in the dispatch schedule will also be communicated to individual stations and be displayed to inform the riders waiting at the stations. The updated dispatch schedule will also be available through the transit system applications on the mobile devices.

Although the trip planning process (e.g., process 1300) and the dispatch process (e.g., process 1800) can be applied in transit systems that operate with regular manual-driven buses, their advantages are most evident with electronic guided buses. As shown in FIG. 17, with on-board trip management capabilities, the electronic guided buses 1702 can automatically determine which track to follow and carry out the trips without increasing drivers' workload. Similarly, if the electronic guided bus 1702 is further equipped with automatic longitudinal control and schedule management, the electronic guided buses 1702 can automatically adjust its speed to adhere to the dispatch schedule and form groups according to the group assignments without driver interactions. Therefore, it is also desirable to provide such schedule management capabilities to the electronic guided buses 1702 with automatic longitudinal control.

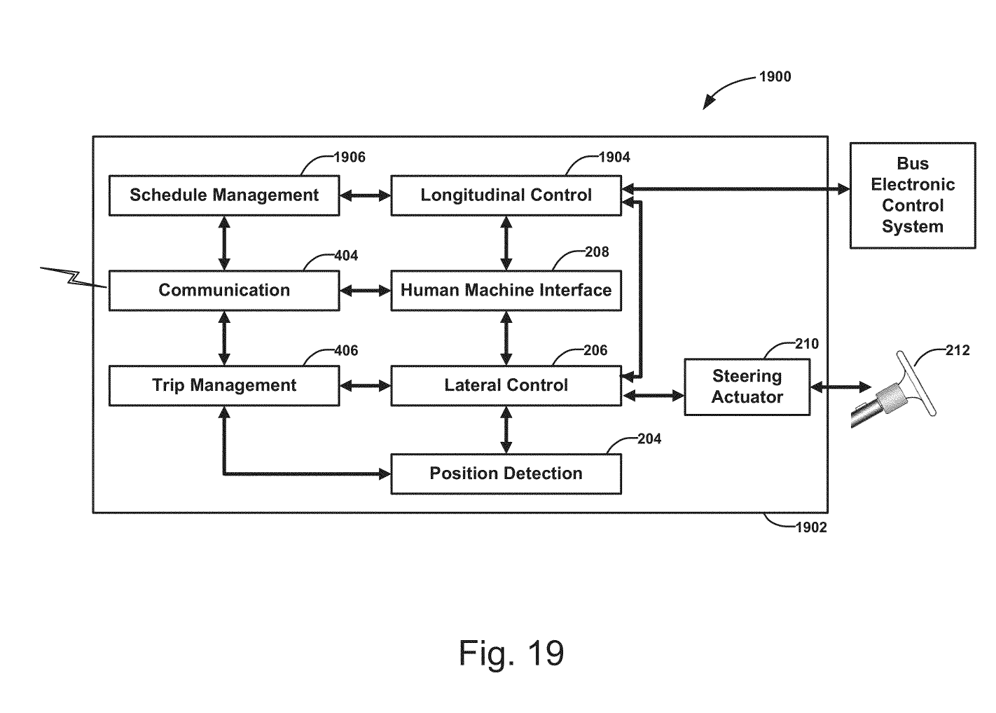

FIG. 19 is a block diagram 1900 of an electronic guidance system 1902 with automatic longitudinal and lateral control as well as the trip management and the schedule management capabilities, where like elements to the electronic guidance system 402 are identified with the same reference number.

The electronic guidance system 1902 further comprises a schedule management module 1906 for determining a desired speed based on the group assignment and the dispatch schedule, as well as a longitudinal control module 1904 for determining the desired throttle command and the desired brake command based on the desired speed from the schedule management module 1906. The desired throttle command and the desired brake command are then sent to the electronic control system of the bus 1702, which controls the throttle (or engine) and the brake systems of the bus according to those commands to achieve the desired speed. In one embodiment, those throttle and brake commands are sent to the bus electronic control system via the control area network (CAN) communications of the bus 1702. Moreover, the longitudinal control module 1904 further gets information such as vehicle speed from the bus via CAN communication as well. Typically, the bus 1702 gets its speed information from its electronic control systems such as engine control and transmission control. The CAN communications and the bus electronic control systems are well-known to those skilled in the art and therefore not described here.

In one embodiment, the communication unit 404 also sends out the current speed and the current location of the bus at a higher frequency, e.g., using a data format different from the message it sends to the control center of the transit system. The communication unit 404 may do this when the location of other vehicles indicate that they are within a certain range. Such information allows the bus to receive the current speed and location of other nearby buses for longitudinal control as well. The schedule management module 1906 can further incorporate this information to determine the headway distance to a preceding vehicle and use it to determine the desired speed. In another embodiment (preferred especially when the bus lane is shared with other vehicles), the electronic guidance system 1902 also includes a headway sensing device (not shown in FIG. 19), such as radars, LIDAR, ultrasonic sensor, and cameras, to detect the headway distance (as well as the changing rate of the headway) to a preceding vehicle. And this information is provided to the schedule management module 1906 (and the longitudinal control module 1904) for the longitudinal control.

The longitudinal control module 1904 and the schedule management module 1906 may reside in the same processor (e.g., an embedded processor or an industrial PC) or they may reside in separate processors. Furthermore, these two modules, the trip management module, and the lateral control module may all reside in the same processor, or they may reside in separate processors.

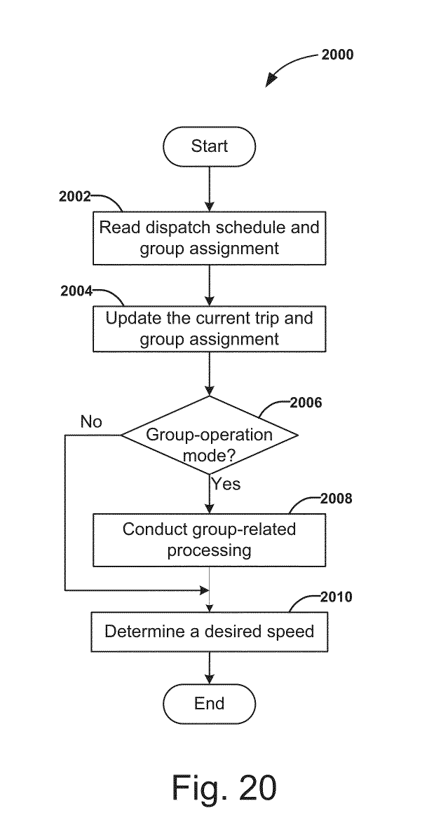

The schedule management module 1906 implements a schedule management method to determine the desired speed based on group assignment and dispatch schedule. FIG. 20 is a flowchart showing the schedule management process 2000 involved in one embodiment of the schedule management method for determining a desired speed based on the group assignment and the dispatch schedule. The process 2000 starts with reading the dispatch schedule and group assignment received by the wireless communication unit 404 in step 2002. The dispatch schedule includes the assigned trips and the corresponding scheduled departure and/or arrival time at each station of each assigned trip. Typically, each trip has its unique trip ID and each station also has its unique ID; accordingly, the dispatch schedule consists of a table including the trip ID, the station ID, and the schedule departure and/or arrival time for each station of each trip. The group assignment information, as described earlier, includes the shared segments and the position of the bus in the group for the shared segments. In one embodiment, the group assignment information also includes the corresponding trip (i.e., the trip ID) to indicate which trip each specific group assignment is associated with. In another embodiment, each group assignment has a unique ID, and the dispatch schedule also includes the group assignment ID with the assigned trips to indicate which group assignments each trip are associated with.

Subsequently in step 2004, the schedule management process 2000 obtains or updates a schedule for the current trip and the current group assignment from the dispatch schedule and the group assignment based on the current location of the bus and the current time. As described earlier with the trip management process 1100 (in FIG. 11), the current location of the electronic guided bus 1702 can be obtained by detecting polarities of the magnetic markers with the position sensing unit 204, decoding a sequence of polarities of consecutive magnetic markers to obtain a code, and determining the current location of the bus based on the code. In another embodiment, the electronic guided bus 1702 is further equipped with a satellite-based navigation system and the current location of the bus 1702 is obtained from the satellite-based navigation system. In an alternative embodiment, the electronic guided bus 1702 is further equipped with an electronic reader and an odometer, and radio beacons are located at specific points along the bus routes. The electronic reader detects signals from the radio beacons when the bus 1702 is driving by and the current location of the bus 1702 is obtained based on the signals from the radio beacons and the travel distance from the odometer.

The current time can be simply the processor time, which may further be synchronized with a time at the control center of the bus transit system via communication. Alternatively, the current time could be a satellite-based synchronized time, e.g., if the bus is equipped with a satellite-based navigation system as the vehicle location device. With the current location of the bus 102 and the current time, the schedule management process 2000 then determines current trip and the current group assignment (i.e., the group assignment associated with the current trip) in the step 2004 based on the dispatch schedule and the group assignment (read in the step 2002). If there is no group assignment corresponding to the current trip, the process 2000 can simply set the current group assignment to NULL. Subsequently in step 2006, the schedule management process 2000 determines a group-operation mode based on the current group assignment and the current location of the bus 1702. More specifically, the schedule management process 2000 determines whether the bus should be in a group-operation mode by checking whether (1) if the current group assignment is not NULL (i.e., there is an associated group assignment) and (2) if the bus 1702 is in a shared segment defined in the current group assignment based on its current location. If either condition is not satisfied, the process 2000 continues to step 2010. If both conditions are satisfied, the schedule management process 2000 continues to step 2008 to conduct group-related processing, which includes parsing the information received from surrounding buses/vehicles by the wireless communication unit 404 to obtain the information from buses in the same group and packaging the bus's own information for the communication unit 404 to broadcast to surrounding buses. The information from the buses 1702 in the same group can be extracted from the information received based on the group ID. If the group ID from another bus matches the bus's own group ID, then this other bus is a bus in the same group. In one embodiment, the information received includes a timestamp, the speed, the location on track, as well as the acceleration. In another embodiment, the information further includes the position of the bus 1702 in the group.

Subsequently in step 2010, the schedule management process 2000 further determines a desired speed, which is then sent to the longitudinal control module 1904. The desired speed is determined based on the group-operation mode and the schedule for the current trip. If the bus 1702 is in a group-operation mode (determined in the step 2004) and the group position of the bus is not 1 (i.e., a following bus in the group), there is a preceding bus ahead; therefore, the desired speed is determined based on the current distance to the preceding bus, a desired distance to the preceding bus, and the current speed of the bus 1702. In one embodiment, the desired distance to the preceding bus (or vehicle if the lane is shared with other vehicles), d, can be a function of the current speed, v; for example, d=a×v, where a is a fixed or variable gain. In another embodiment, the desired headway can be set to be smaller if the bus 1702 is in the group-operation mode (as determined in the step 2006) since the speed and the acceleration of a preceding bus is known from the information received by the communication unit 404.

In a further embodiment, the current speed and acceleration of the preceding bus is also used in the determination of the desired speed. Similarly, the current speed and acceleration of the lead bus in the group can also be incorporated in the determination of the desired speed. The dynamic relationship can be established between the current distance and the current speed of the bus 1702, the current speed of the preceding bus, as well as their accelerations. And feedback control can be established based on this dynamic relationship and the desired distance so as to determine the desired speed.

If the bus 1702 is not in a group-operation mode or if the bus 1702 is a lead bus, the desired speed is determined as follows: (1) if there is a preceding bus (e.g., if the distance to a preceding bus is within a predefined threshold), the desired speed is determined based on the current distance to the preceding bus, the desired distance to the preceding bus, and the current speed of the bus 1702; (2) if there is no preceding bus (e.g., if the distance to a preceding bus is greater than a predefined threshold), the desired speed is then determined based on the current location of the bus 1702, the location of the next station, and the scheduled time to the next station.

The above description on the determination of a desired speed in the step 2010 is with the assumption that the buses always have the priority in intersections, which can be achieved by implementing transit signal priority (TSP) techniques. The TSP techniques rely on detecting transit vehicles as they approach an intersection and adjusting the signal timing dynamically to improve service for the transit vehicle. Therefore, the traffic lights may not be a consideration in the determination of the desired speed. However, for transit operations where the traffic lights are not necessary set with buses having the priority, the schedule management process then does need to take into the traffic signals into consideration in determining the desired speed in the step 2010. In such a transit system, the communication unit 404 on board the electronic guided bus further receives the traffic signal timings either from the control center of the transit system or from the communication devices installed on road infrastructure (e.g., at traffic light poles or traffic light control boxes) that are connected to the traffic light control boxes. The schedule management process 2000 further reads the traffic signal timing in the step 2002 and updates the traffic signal timing of its next intersection in the step 2004. Subsequently in the step 2010, the schedule management process 2000 determines a time-to-clear-the-intersection based on the current speed and the traffic signal timing of the next intersection; this time-to-clear-intersection is the time the bus 1702 should have crossed the intersection before the traffic light turns from green to yellow. If the bus 1702 is not in the group-operation mode or the bus is a lead bus, the schedule management process further incorporates this time-to-clear-the-intersection and the distance to the intersection to determine the desired speed. More specifically, the distance to the intersection is determined based on the location of the intersection and the location of the bus 1702 (if it is not in group-operation mode) or the location of the last bus in a group (if it is in the group-operation mode).

After setting the desired speed, the schedule management process 2000 exits to wait for the next processing cycle. The longitudinal control module 1904 reads the desired speed and determines the throttle and brake commands that are required to achieve the desired speed. The determination of the throttle and brake commands based on the desired speed and the current speed is well-known to those skilled in the art and therefore not described here.

With the dynamic dispatch method for dispatching buses in groups and the schedule management capabilities of the electronic guided buses, an intelligent transit system that is capable of dynamically planning the trips and dispatching buses in groups to better meet the ridership demand and maximize transit efficiency without increasing driver workload can be developed.

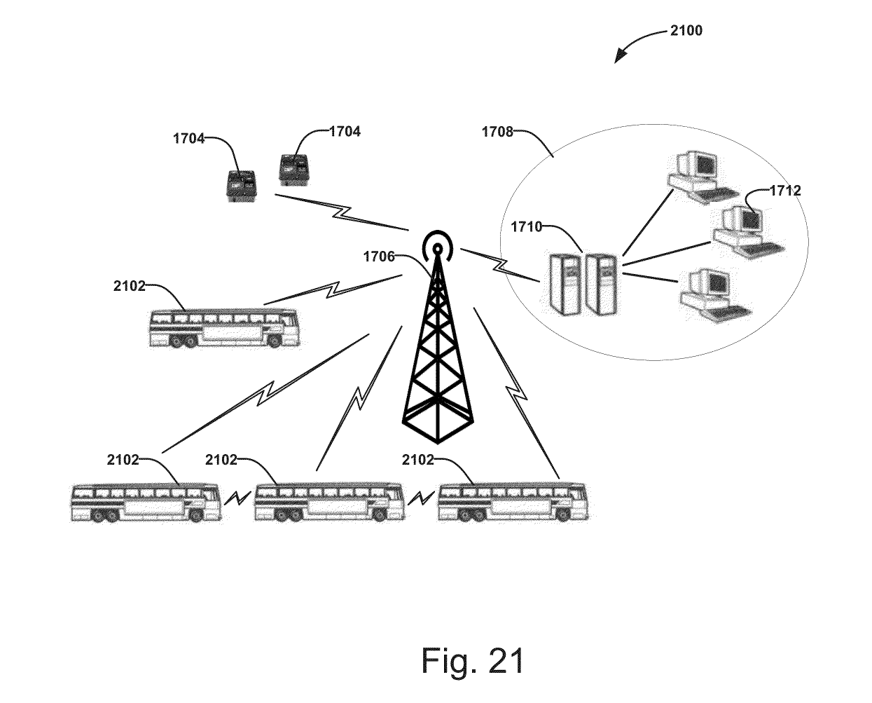

FIG. 21 is a schematic showing another embodiment of an intelligent transit system 2100 similar to the transit system 1700, where like elements are identified by the same reference number, and which includes a plurality of electronic guided buses 2102. Each electronic guided bus 2102 is equipped with an electronic guidance system for receiving a dispatch schedule and a group assignment via communication and automatically controlling the bus to perform scheduled service according to the dispatch schedule and the group assignment. Compared with the electronic guided buses 1702 which are guided to follow an electronic track via automatic lateral control, the electronic guided buses 2102 are under full automatic control to follow an electronic track and to adhere to the dispatch schedule and to execute the group assignment. One embodiment of the electronic guidance system is the system 1902 in FIG. 19.

The dispatch processor 1710 estimates ridership demands based on the passengers' trip information, determines a plurality of trips based on estimated ridership demands, determines a service interval for each trip, generates group assignments based on the service intervals, determines a dispatch schedule for each bus based on the service intervals and the group assignments, communicates the dispatch schedule to each bus, and communicates group assignments to buses assigned in groups via the communication device 1706.

The communication unit 404 on the bus 2102 receives the dispatch schedule and passes it to the trip management module 406 and the schedule management module 1906. The trip management module 406 determines the track to follow to carry out each specific trip in the dispatch schedule and the schedule management module 1806 determines a desired speed for the bus 2102 to adhere to the dispatch schedule. Moreover, the dispatch processer 1710 also communicates the group assignment information to each bus 2102 that would be in a group in any of its trips. The communication unit 404 of the bus 2102 receives the group assignments and passes them to the schedule management module 1906, which further incorporates the group assignment in the determination of the desired speed so as to form a group or separate from a group according to the group assignment.

In addition, the electronic guidance system 1902 may further include a human machine interface 208 for providing information to an operator and for accepting inputs from the operator. The human machine interface 208 gets the dispatch schedule from the communication unit 404 and informs the received dispatch schedule to an operator of the bus 2102 as well as the passengers on board the bus 2102 so that the bus operator can monitor the operation of the electronic guided bus 2102 and the passengers can be informed of any changes in the trip and schedule. The human machine interface 208 may inform the operator and the passengers by displaying the information on screen panels or by announcing it via speakers. The human machine interface 208 may also get the group assignment received by the communication unit 404 and inform the operator of the group assignment information.

Although the bus 2102 is equipped with the electronic guidance system 1902 to operate automatically, the bus 2102 can also be manually driven either in the longitudinal control (i.e., controlling the speed via throttle and brake pedals) or in the lateral control (i.e., turning the steering wheel) in this intelligent transit system. The dispatch schedule and the group assignment can be provided to the bus operator via the human machine interface 208 and the operator decides which track to follow or which speed to maintain accordingly. This would be necessary in situations where faults are detected in the electronic guidance system 1902 and limit the capability of the electronic guidance system 1902 temporarily (e.g., until the faulty components are fixed).

In a further embodiment, the dispatch processor 1710 also generates an overtaken command for a preceding bus followed by a following bus and communicates the overtaken command to the preceding bus. Upon receiving the overtaken command, the preceding bus takes the next bypass track available to allow the following bus to overtake it. The bypass track layout is similar to those shown in FIGS. 9 and 10 with the station removed. Such an overtaken command is desirable in various situations such as when the following bus is running behind schedule and needs to catch up, or when a preceding bus is experiencing some failures and needs to be pulled out of the service, or when the positions in a group need to be changed, and so on. Thus, in one embodiment, these types of situations are defined and stored in the memory of the dispatch processor 1710. The dispatch processor 1710 checks whether any of the situations occurred; if so, the dispatch processor 1710 identifies the preceding bus and issues an overtaken command to the preceding bus. The dispatch processor 1710 may also specify the location of the next bypass track in the overtaken command. In a further embodiment, the dispatch processor 1710 may generate an overtaking command for the following bus, and the following bus will actively cooperate with the preceding bus to execute the overtaking maneuver.

Alternatively, the preceding bus could remain on the main track while the following bus takes the bypass track to overtake the preceding bus. There could be a default option for which bus to take the bypass track. In a further embodiment, the dispatch processor 1710 specifies which bus is the one to take the bypass track in the overtaken and overtaking commands.

Although the present invention has been described above with particularity, this was merely to teach one of ordinary skill in the art how to make and use the invention. For example, the buses could also be other types of transit vehicles and the electronic guidance technologies can be either vision-based, or DGPS-based, or magnetic sensing based technologies. In addition, the trip management process and the schedule management process can be run by modules on board each bus or be run by computers at the control center of the bus transit system. Many additional modifications will fall within the scope of the invention, as that scope is defined by the following claims.

What is claimed is:

1. A method for providing trip management for an electronic guided bus that follows an electronic track, comprising:
receiving an assigned trip from a bus dispatch system;
obtaining junction information based on the assigned trip, wherein the junction information comprises a junction location and a desired track for each junction on the assigned trip;
obtaining a current location of the electronic guided bus;
identifying a junction the bus is currently at based on the current location of the bus and the junction information; and
setting a main track for the bus to follow based on the desired track for the identified junction;
whereby the main track is the track that the electronic guided bus follows for the assigned trip.

2. The method of claim 1, wherein the electronic track is defined by magnetic markers installed in a roadway and the current location of the electronic guided bus is obtained by:
detecting, with a position sensing unit, polarities of the magnetic markers,
decoding a sequence of polarities of consecutive magnetic markers to obtain a code, and
determining the current location of the bus based on the code.

3. The method of claim 1, wherein the electronic guided bus is equipped with a satellite-based navigation system, and wherein obtaining a current location of the electronic guided bus includes obtaining the current location of the bus from the satellite-based navigation system.

4. The method of claim 1, wherein the electronic guided bus is equipped with an electronic reader and an odometer, and wherein obtaining a current location of the electronic guided bus includes:
reading, with the electronic reader, signals from radio beacons located at specific points along the assigned trip;
obtaining a travel distance from the odometer; and
determining the location of the bus based on the signals from radio beacons and the travel distance.

5. The method of claim 1, wherein the desired track for a junction is defined by a sequential number representing the desired track's location among all tracks at the junction in a predefined direction.

6. The method of claim 1 further comprising generating a reference trajectory for the electronic guided bus to gradually switch to follow the main track, wherein the reference trajectory consists of a series of offsets.

7. A method for trip planning for a bus transit system, comprising estimating ridership demands and generating trip arrangements based on the ridership demands.

8. The method of claim 7, wherein estimating ridership demands includes obtaining numbers of passengers onboard buses, determining origins and destinations of the passengers, obtaining historical ridership demands, and estimating ridership demand based on the number of the passengers, the origins and destinations, and the historical ridership demand.

9. The method of claim 7, wherein generating trip arrangements based on the ridership demands includes creating high-demand trips based on origin-destination pairs that have high ridership demand; associating origin-destination pairs with high-demand trips; and creating low-demand trips by extending high-demand trips to origins and destinations of low-demand origin-destination pairs.

10. An intelligent transit system comprising:
a plurality of electronic guided buses, wherein each bus is equipped with an electronic guidance system for receiving an assigned trip via communication and automatically steering a bus to carry out the assigned trip;
a plurality of ridership tracking devices for obtaining passenger trip information;
a control center comprising at least one dispatch processor, wherein the dispatch processor estimates ridership demands based on the passengers' trip information, determines a plurality of trips based on estimated ridership demands, generates dispatch schedule for the trips, assigns trips to the electronic guided buses, and communicates assigned trips to the electronic guided buses; and
at least one communication device for communicating with the electronic guided buses, the ridership tracking devices, and the dispatch processor.

11. The intelligent transit system of claim 10, wherein each electronic guidance system includes:
a communication unit for receiving the assigned trip;
a trip management module for determining a track to follow based on the assigned trip so as to carry out the assigned trip;
a position sensing unit for providing position deviation of the bus with respect to the track;
a lateral control module for determining a desired steering angle based on the position deviation from the position sensing unit; and
a steering actuator unit to turn the steering wheel based on the desired steering angle.

12. The intelligent transit system of claim 11, wherein the track is defined by magnetic markers installed in the roadway and wherein:
the position sensing unit further detects polarities of the magnetic markers and decodes a sequence of polarities of magnetic markers to obtain a code,
the lateral control module further determines a current location of the electronic bus based on the code, and
the communication unit further communicates the current location of the bus to the control center.

13. The intelligent transit system of claim 11, further comprising a location detection device for detecting a current location of the electronic guided bus, wherein the communication unit further communicates the current location of the electronic guided bus to the control center.

14. The intelligent transit system of claim 11, wherein the trip management module determines a track to follow by:
obtaining junction information based on the assigned trip, wherein the junction information comprises a junction location and a desired track for each junction on the assigned trip;
obtaining a current location of the electronic guided bus;
identifying a junction the bus is at based on the current location of the bus and the junction information; and
setting the track for the bus to follow based on the desired track for the identified junction.

15. The intelligent transit system of claim 14, wherein the desired track for a junction is defined by a sequential number representing the desired track's location among all tracks at the junction in a predefined direction.

16. The intelligent transit system of claim 11, wherein:
the trip management module further generates a reference trajectory, wherein the reference trajectory consists of a series of offsets; and
the lateral control module incorporates the reference trajectory to determine the desired steering angle;
whereby the electronic guided bus is guided smoothly to transition from one track to another track.

17. The intelligent transit system of claim 10, wherein the plurality of ridership tracking devices include a plurality of passenger counting devices, each on board an electronic guided bus for counting passengers onboard and alights from the bus and being connected to the electronic guidance system for communicating the passenger counts.

18. The intelligent transit system of claim 10, wherein the plurality of ridership tracking devices include:
a plurality of electronic fare boxes, each at a station for counting passengers entering and exiting the station, and
a plurality of ticket vending machines, each at a station for issuing tickets and reporting an origin and a destination for each ticket issued.

19. The intelligent transit system of claim 10, wherein the dispatch processor estimates ridership demand by obtaining numbers of passengers onboard buses, determining origins and destinations of passengers, obtaining historical ridership demands, and estimating ridership demand based on the number of passengers, the origins and destinations, and the historical ridership demand.

20. The intelligent transit system of claim 10, wherein the dispatch processor determines the plurality of trips based on estimated ridership demands by creating high-demand trips based on origin-destination pairs that have high ridership demand; associating origin-destination pairs with high-demand trips; and creating low-demand trips by extending high-demand trips to origins and destinations of low-demand origin-destination pairs.
